(19) United States
(12) Patent Application Publication
(10) Pub. No.: US 2013/0332632 A1
(43) Pub. Date: Dec. 12, 2013

(54) HOLISTIC IDENTIFICATION OF AN ELECTRONIC DEVICE

(71) Applicant: APPLE INC., Cupertino, CA (US)

(72) Inventors: Shailesh Rathi, San Jose, CA (US); Edwin Foo, San Mateo, CA (US); Jason J. Yew, San Jose, CA (US); Gregg Golembeski, San Francisco, CA (US)

(73) Assignee: Apple Inc., Cupertino, CA (US)

(21) Appl. No.: 13/685,522

(22) Filed: Nov. 26, 2012

Related U.S. Application Data
(60) Provisional application No. 61/657,582, filed on Jun. 8, 2012.

(51) Int. Cl. G06F 3/00

(52) U.S. Cl. CPC G06F 3/00
USPC 710/38

(57) ABSTRACT

A holistic identification process can facilitate reliable interoperation between accessories and host devices, particularly where the accessory includes multiple components and/or multiple communication interfaces. During an identification process, the accessory can provide information about every communication interface it is capable of using to communicate with the host as well as information about various components that the accessory has available for use in interacting with the host device. During subsequent interoperation, the host device can use the identification information to determine a response to an input received from the accessory and/or to determine an interface to use to deliver information to the accessory.

### CROSS-REFERENCE TO RELATED APPLICATION

This application claims the benefit of U.S. Provisional Application No. 61/657,582, filed Jun. 8, 2012, entitled “Holistic Identification of an Electronic Device,” the entire disclosure of which is incorporated by reference for all purposes.

### BACKGROUND

The present disclosure relates in general to communicating data between electronic devices and in particular to holistic identification of one device to another.

Portable electronic devices, such as smart phones, tablet computers, media players, and the like, have become ubiquitous. Various accessories have been created to interoperate with portable electronic devices to extend their functionality and/or enhance the user experience. Examples of accessories include chargers, speaker docks, in-vehicle docks that provide options for controlling the portable device using the vehicle's console, workout equipment, health monitoring accessories (e.g., heart rate, blood pressure or glucose meters), and so on. Accessories can be designed to interoperate with multiple portable electronic devices that may differ in their form factor and capabilities (e.g., processing power; firmware version; battery life, presence or absence of cameras, microphones, or other components). In addition to variability in “internal” components, accessories can also incorporate a variety of communication interfaces for purposes of communicating with portable devices.

To provide a reliably pleasant experience for a user operating a portable device in conjunction with an accessory, it can be desirable to verify that the accessory will operate correctly with a particular portable device. However, the sheer variety of possible accessories, as well the number of different portable devices to which a particular accessory can be connected and the number of possible communication interfaces, makes such verification difficult.

### SUMMARY

Certain embodiments of the present invention provide a holistic identification process that can facilitate reliable interoperation between accessories and host devices (including portable devices), particularly where the accessory includes multiple components and/or multiple communication interfaces. The process can be executed as part of initializing communication when the accessory connects to a host on a first communication channel via a first interface. At that time, the accessory can provide identification information that includes information about every communication interface it is capable of using to communicate with the host (e.g., USB, Wi-Fi, Bluetooth, UART, and any other interfaces). The accessory can subsequently establish a second (or third, etc.) connection to the host via any of its interfaces, and the host can recognize that the second connection is to the same accessory. Based on this, the host can use the initial identification information when communicating with the accessory over the second connection. When the accessory has established multiple connections to the host, the host can select an optimal routing for particular communications. Further, if one connection becomes disconnected, the host can continue to communicate with the accessory as long as at least one connection is available. Routing and re-routing of communications to various interfaces can be made transparent to the user.

In some embodiments, the identification information provided by the accessory can also include information about various components that the accessory has available for use in interacting with the host device. For example, the accessory can provide information about its display device(s), speakers, and/or user-operable input devices (e.g., keyboard, keypad, buttons, dials, touchscreens, trackpads, etc.). The accessory can also define “bundles” or groupings of components based on a common purpose or common physical location. The host device can use this information to tailor its interaction with the accessory, e.g., by routing particular information to specific accessory components or by responding differently to input signals from the accessory depending on which component was the source of the input signal.

Obtaining complete identification of all available communication interfaces and/or components from the accessory at the outset of interoperation can enhance the ability of the host device to interoperate with the accessory in a coordinated manner.

Certain aspects of the invention relate to methods of identifying an accessory device to a host device. An accessory can establish a communication channel with the host device using a first communication interface and send identification information to the host via the communication channel. The identification information can include an interface descriptor of at least one other communication interface that the accessory is capable of using to communicate with the host. The identification information can also include other information, such as a component descriptor of each of a number of components of the accessory, including, e.g., an audio output component, a video output component, and/or a user input component. The component descriptor in some instances can include a purpose indicator identifying a particular functionality with which the component is to be associated. The identification information can also include a bundle descriptor that associates some (or all) of the components into a bundle, e.g., based on having a common location and/or a common associated functionality or purpose.

Certain aspects of the invention relate to a host device communicating with an accessory. The host device can detect a connection to an accessory via a first communication channel using a first communication interface. Via this channel, the host can receive identification information from the accessory. The identification information can include an interface descriptor providing information about a second communication interface that the accessory is also capable of using to communicate with the host, as well as another interface descriptor providing information about the first communication interface. If the host accepts the identification information, the host can communicate with the accessory using the first communication interface and the second communication interface. For example, the host device can determine that particular data is to be sent to the accessory and can select one of the first communication interface and the second communication interface via which to send the data. As another example, the host device can receive an input signal from the accessory via one of the communication interfaces. Based on the input signal and on which one of the communication interfaces was used to deliver the input signal, the host can determine an action to take.

Certain aspects of the invention relate to a host device communicating with one or more accessories. The host can detect a connection to a first accessory via a first communication channel using a first communication interface. Via that channel, the host can receive identification information from the first accessory. This information can include descriptors of multiple communication interfaces that the first accessory is capable of using to communicate with the host. While the first accessory remains connected, the host device can detect a connection request via the second communication interface and can determine whether the connection request was generated by the first accessory. If the connection request was generated by the first accessory, the host can communicate with the first accessory using both the first communication interface and the second communication interface. If not, the host can use the second communication interface to communicate with a second accessory, which can provide its own identification information. In some cases, there can be a limit on the number of accessories that can be connected to the host at any given time.

Certain aspects of the invention relate to accessory devices that have multiple components, including, e.g., an audio component, a video component, and/or a user input component. The accessory device can also have multiple communication interfaces operable to communicate with a host device. Identification logic in the accessory device can provide identification information to the host device via one of the of communication interfaces. The identification information can include a descriptor of each of the components and a descriptor of each of the communication interfaces. The descriptors can provide information about the configuration and/or capabilities of particular components (e.g., applicable signal formats, sizes, intended uses, etc.). The identification information can also include a bundle descriptor that associates two or more of the components with each other, thereby defining a bundle; the bundle descriptor can also associate at least one of the accessory's communication interfaces with the bundle.

Certain aspects of the invention relate to host devices that have execution logic capable of executing multiple different functions and multiple communication interfaces operable to communicate with accessories. Control and routing logic can be coupled between the execution logic and the communication interfaces, and the control and routing logic can be configured to selectably route information from the execution logic to one or another of the host communication interfaces. Identification logic in the host device can be configured to receive, from an accessory device via one of the host communication interfaces, an identification message containing identification information. This information can include descriptors of the accessory's components and/or communication interfaces. The route selected for particular information from the execution logic to one of the host communication interfaces can be determined based in part on the identification information, and actions to be taken by the host device in response to input signals received from the accessory can be determined based in part on which one of the accessory communication interfaces sent the input signal.

The following detailed description together with the accompanying drawings will provide a better understanding of the nature and advantages of the present invention.

### BRIEF DESCRIPTION OF THE DRAWINGS

FIG. 1 shows a host device and an accessory according to an embodiment of the present invention.

FIG. 2 is a simplified block diagram of a system including a host device and an accessory according to an embodiment of the present invention.

FIG. 3 illustrates a format for a message that can be implemented according to an embodiment of the present invention.

FIG. 4 is a table showing identification messages according to an embodiment of the present invention.

FIG. 5 is a table listing parameters that can be defined for an identification message according to an embodiment of the present invention.

FIG. 6 is a table illustrating subfields of an audio component descriptor field according to an embodiment of the present invention.

FIG. 7 is a table illustrating subfields of a video component descriptor field according to an embodiment of the present invention.

FIG. 8 is a table illustrating subfields of an input component descriptor field according to an embodiment of the present invention.

FIG. 9 is a table illustrating subfields of a bundle descriptor field according to an embodiment of the present invention.

FIG. 10 is a flow diagram of a process for negotiating identification that can be implemented in a host device according to an embodiment of the present invention.

FIG. 11 is a flow diagram of an identification process that can be implemented in an accessory according to an embodiment of the present invention.

FIG. 12 is a flow diagram of a process for a host device that can manage multiple connections to one or more accessories according to an embodiment of the present invention.

FIG. 13 is a flow diagram of a process usable by a host device to process input signals received from an accessory according to an embodiment of the present invention

FIG. 14 is a flow diagram of a process usable by a host device to process input signals received from an accessory according to an embodiment of the present invention.

### DETAILED DESCRIPTION

Certain embodiments of the present invention provide a holistic identification process that can facilitate reliable interoperation between accessories and host devices (including portable devices), particularly where the accessory includes multiple components and/or multiple communication interfaces. The process can be executed as part of initializing communication when the accessory connects to a host on a first communication channel via a first interface. At that time, the accessory can provide identification information that includes information about every communication interface it is capable of using to communicate with the host (e.g., USB, Wi-Fi, Bluetooth, UART, and any other interfaces). The accessory can subsequently establish a second (or third, etc.) connection to the host via any of its interfaces, and the host can recognize that the second connection is to the same accessory. Based on this, the host can use the initial identification information when communicating with the accessory over the second connection. When the accessory has established multiple connections to the host, the host can select an optimal routing for particular communications. Further, if one connection becomes disconnected, the host can continue to communicate with the accessory as long as at least one connection is available. Routing and re-routing of communications to various interfaces can be made transparent to the user.

In some embodiments, the identification information provided by the accessory can also include information about various components that the accessory has available for use in interacting with the host device. For example, the accessory can provide information about its display device(s), speakers, and/or user-operable input devices (e.g., keyboard, keypad, buttons, dials, touchscreens, trackpads, etc.). The accessory can also define “bundles” or groupings of components based on a common purpose or common physical location. The host device can use this information to tailor its interaction with the accessory, e.g., by routing particular information to specific accessory components or by responding differently to input signals from the accessory depending on which component was the source of the input signal.

Obtaining complete identification of all available communication interfaces and/or components from the accessory at the outset of interoperation can enhance the ability of the host device to interoperate with the accessory in a coordinated manner.

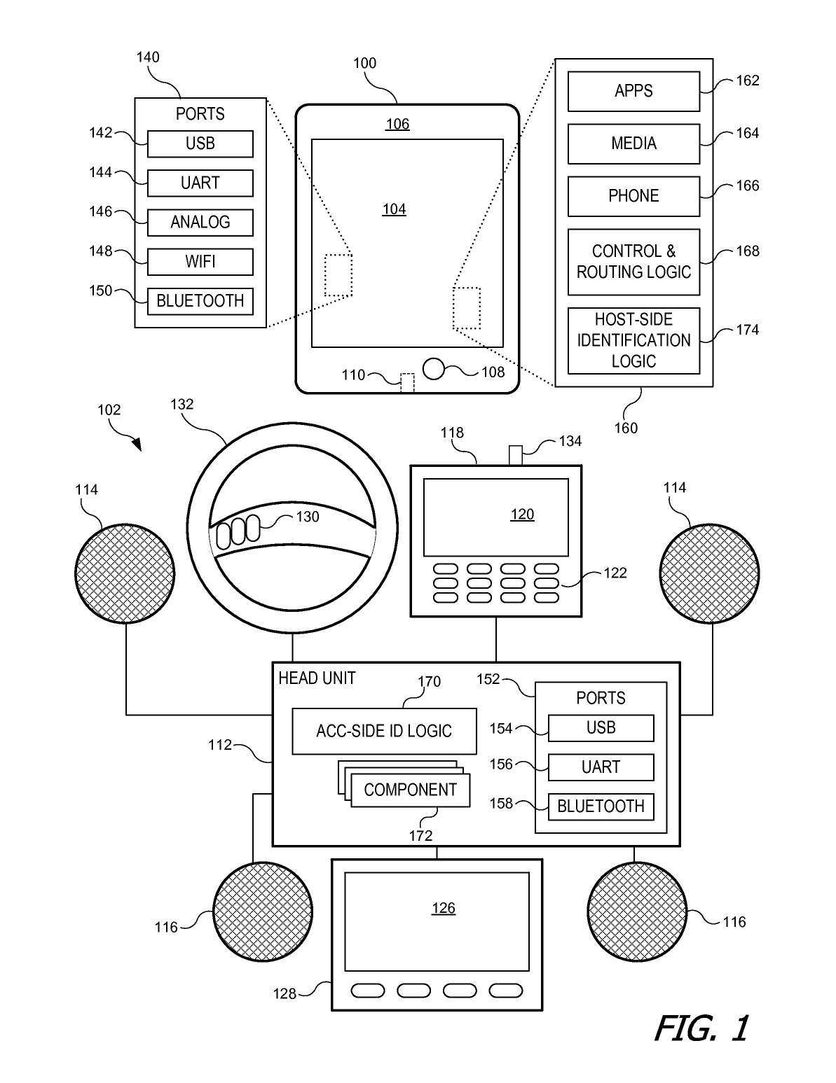

FIG. 1 shows a host device 100 and an accessory 102 according to an embodiment of the present invention.

Host device 100 can be, for example, a handheld device such as a media player, smart phone, or personal digital assistant; a tablet computer; a laptop computer; a desktop computer; or any other electronic device capable of communicating with accessory devices. In some embodiments, host device 100 can be a portable device (meaning a device that is easily carried by a user from place to place), but this is not required. In the example shown, host device 100 is a tablet computer with a display area 104 surrounded by bezel 106 and a control button 108. A receptacle connector 110 is provided at the bottom of host device 100 (e.g., recessed into the housing) to allow accessories to be physically connected to host device 100.

Accessory 102 can be any accessory capable of interacting with host device 100, such as a speaker dock or speaker system, a media console, an automobile head unit, or the like. In the example shown, accessory 102 is a multi-component, multifunction device such as an entertainment and information system provided in a motor vehicle. A head unit 112 coordinates the operation of various components. The components can include, for example, front speakers 114; rear speakers 116; a front console unit 118 with a display 120 and input controls 122; a rear console unit 124 with its own display 126 and input controls 128; and additional controls 130 mounted in steering wheel 132. Accessory 102 can provide support for a number of services. For example, accessory 102 can present navigation information to a driver on front display 120 while presenting a movie or other entertainment on rear display 126. In some embodiments, accessory 102 can provide different audio streams to different speakers. Thus, for example, audio associated with a movie being presented on rear display 126 can be provided using rear speakers 116 while a different audio stream (e.g., from a radio station) can be provided to the driver and any front-seat passengers using front speakers 114.

In the example shown, accessory 102 has a plug connector 134 located within or near front console unit 118 that can be inserted into receptacle connector 110 to provide electrical and mechanical connections between accessory 102 and host device 100. In some embodiments, the electrical connections can include both power and data connections, allowing accessory 102 to deliver power to host device 100 and/or to receive power from host device 100. While a direct connection between connectors 110 and 134 is one option, it is to be understood that some embodiments can use an indirect connection, e.g., via a cable or adapter. In some embodiments, host device 100 and accessory 102 may be capable of communicating wirelessly, e.g., using radio-frequency communication technology such as Wi-Fi or Bluetooth, near-field communication technology, infrared communication or the like, in addition to or instead of a wired signal path as provided by connectors 110 and 134. In some embodiments, multiple communication paths can be concurrently established between host device 100 and accessory 102, with different types of information being selectively routed over different paths.

By communicating, e.g., via connectors 110 and 134, host device 100 and accessory 102 can interoperate to support various functionalities. For example, in some embodiments, host device 100 can stream media content for presentation by accessory 102 and can also provide status information (e.g., information about a currently playing media track) to accessory 102 for presentation to the user, e.g., on display 120 and/or display 126. A user can operate controls 122, 128, or 130 of accessory 102 to control playback of the media content, e.g., play/pause, or selection of a different track. As another example, accessory 102 (or host device 100) can include a radio receiver (not shown) to receive media content, e.g., from FM, AM, or satellite transmitters. Portable device 100 (or accessory 102) can be used to control operation of the radio receiver, e.g., channel or program selection. Many other types of interoperation are possible.

Further, host device 100 and accessory 102 can communicate using a variety of different communication channels or paths. For example, as shown in inset 140, host device 100 can support a number of different communication interfaces, or ports. The ports can include wired ports such as USB (universal serial bus) port 142, UART (universal asynchronous receiver/transmitter) port 144, and analog A/V port 146, as well as wireless ports such as Wi-Fi port 148 and Bluetooth port 150. In some embodiments, wired ports 142, 144, 146 can be implemented using the hardware of connector 110 to provide signal routing; wireless ports 148, 150 can be implemented using suitable antenna hardware. Similarly, head unit 112 of accessory 102 can support multiple different communication interfaces, or ports, 152. In this example, the ports include a USB port 154, a UART port 156, and a Bluetooth port 158. Depending on particular details of configuration, host device 100 can be communicating with accessory 102 via multiple different ports at the same time (or at different times) in connection with different functionality.

For example, as shown in inset 160, host device 100 can support various virtual interactive devices that receive input from a user and/or produce output to the user, including application programs (apps) 162, media playback engine 164, and mobile phone engine 166. In some instances, multiple virtual devices can be concurrently active. Control and routing logic 168 can coordinate delivery of information from virtual devices 162-166 to accessory 102 and from accessory 102 to virtual devices 162-166.

In order to optimize information delivery, it can be useful for control and routing logic 168 to have “holistic” information about accessory 102, such as information indicating what components are available to interoperate with host device 100, for what purposes, and via what ports or interfaces. For example, if control and routing logic 168 is aware that display 120 is positioned to present information to a driver of a vehicle while display 126 is positioned to present media content to rear-seat passengers, then control and routing logic 168 can implement routing rules to make sure content is delivered appropriately. For instance, caller-ID info from an incoming call can be routed to display 120 while a movie is streamed to display 126. As another example, if a call comes in, control and routing logic 168 can continue to deliver media content to rear display 126 and speakers 116 (possibly at reduced volume) while providing audio from the phone call to front speakers 114.

Holistic identification information can also be useful when control and routing logic 168 receives information from the accessory. For example, input from rear-seat controls 128 can be interpreted as controlling media being streamed to the rear seat (e.g., play, pause, asset selection), while input from steering-wheel controls 130 can be interpreted as controlling a different operation, e.g., initiating or terminating a phone call or controlling a different media stream that is being delivered to the front seat.

To facilitate interoperation, host device 100 and accessory 102 can negotiate an operating agreement that defines the functionality they will mutually support and that also specifies the various components and capabilities of accessory 102. In some embodiments, the agreement is negotiated when host device 100 and accessory 102 establish a connection, and negotiating the agreement can be part of a device identification process.

For example, head unit 112 of accessory device 102 can include accessory-side identification logic 170 that makes use of component descriptors 172 for each component of the accessory. A “component” can be, for example, a specific port (communication interface) or a particular input/output device that can interact with host device 100, and descriptors 172 can include information about each component. In the embodiment of FIG. 1, examples of components can include front console display 120, front console keyboard 122, front speakers 114, steering wheel controls 130, rear display 126, rear controls 128, and rear speakers 116, as well as USB port 154, UART port 156, and Bluetooth port 158.

In some instances, component descriptors 172 can also include “bundle” descriptors that identify groups of components as being related into a logical unit having a particular purpose. Thus, for example, rear display 126, rear controls 128 and rear speakers 116 can be further identified as components of a bundle whose purpose is, e.g., “passenger entertainment.” The component and bundle descriptors can be defined, e.g., within the accessory firmware stored in head unit 112, and provided to host device 100 by accessory-side identification logic 170 during an identification process, examples of which are described below.

During the identification process, host-side identification logic 174 within host device 100 can receive the identification information, including component and bundle descriptors 172, from accessory-side identification logic 170. Using this information, host device 100 can determine how to interact with accessory 102, e.g., how control and routing logic 168 should direct user input and user output.

In some embodiments, host device 100 and accessory device 102 can establish an initial communication channel via any one of the available ports or interfaces. For example, if a user connects connectors 110 and 134, a physical connection between host-side UART port 144 and accessory-side UART port 156 can be established first. As another example, a user can initiate a wireless pairing without physically connecting the devices; for example, host-side Bluetooth port 150 and accessory-side Bluetooth port 158 can establish a pairing.

Once the initial channel is established, accessory-side identification logic 170 can send an identification message to host device 100 via that channel. In some embodiments, the identification message represents a proposal for terms of interoperation between host device 100 and accessory 102. This proposal can include information identifying the accessory, component descriptors 172 for each component the accessory will make available for interaction with the host device, and other information, e.g., information indicating specific functionality to be invoked during interoperation between accessory 102 and host device 100. Host-side identification logic 174 can receive the identification message and determine whether to accept or reject the operating proposal. This determination can be made by referring to information within the proposal as well as information about the capabilities and/or security settings of host device 100. Host-side identification logic 174 can communicate its determination to accessory-side identification logic 170. If the proposal is accepted, accessory 102 and host device 100 can begin to interoperate. While interoperating, accessory 102 and host device 100 can establish other communication channels; in some instances, the initially established channel can be closed, and the accessory and host can remain connected (and capable of continuing interoperation) for as long as at least one channel is continually open. If the proposal is rejected, accessory 102 can submit a modified proposal, and negotiation can continue until accessory 102 presents a proposal that is accepted by host 100.

It will be appreciated that the host device and accessory of FIG. 1 are illustrative and that variations and modifications are possible. A host device and/or an accessory can implement any combination of functionality. In some embodiments, rather than the accessory presenting identification information to the host, the host can present identification information to the accessory, and the accessory can issue a decision accepting or rejecting a proposal from the host.

Identification messages and decisions can be communicated using various message formats and signaling techniques, with details depending on the accessory protocol. The decision process can implement a number of rules incorporating any available information about the accessory and/or the host. Examples of suitable formats and processes are described below.

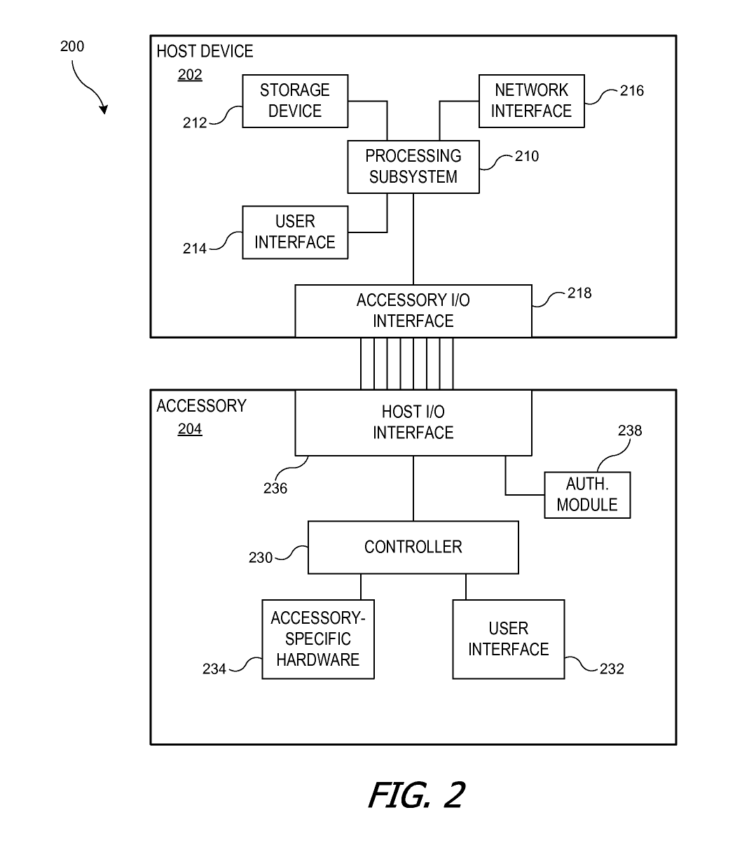

A host device and an accessory can be implemented as separate computing devices that communicate via one or more interfaces to support interoperation. FIG. 2 is a simplified block diagram of a system 200 including a host device 202 and accessory 204 according to an embodiment of the present invention. In this embodiment, host device 202 (e.g., implementing host device 100 of FIG. 1) can provide computing, communication, media playback, and/or other capabilities. Host device 202 can include processing subsystem 210, storage device 212, user interface 214, network interface 216, and accessory input/output (I/O) interface 218. Host device 202 can also include other components (not explicitly shown) such as a battery, power controllers, and other components operable to provide various enhanced capabilities.

Storage device 212 can be implemented, e.g., using disk, flash memory, or any other non-transitory storage medium, or a combination of media, and can include volatile and/or non-volatile media. In some embodiments, storage device 212 can store media objects such as audio files, video files, image or artwork files; information about a user's contacts (names, addresses, phone numbers, etc.); information about a user's scheduled appointments and events; notes; and/or other types of information. In some embodiments, storage device 212 can also store one or more application programs to be executed by processing subsystem 210 (e.g., video game programs, personal information management programs, media playback programs, etc.).

User interface 214 can include input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital-to-analog or analog-to-digital converters, signal processors, or the like). A user can operate input devices of user interface 214 to invoke the functionality of host device 202 and can view and/or hear output from host device 202 via output devices of user interface 214.

Processing subsystem 210 can be implemented as one or more integrated circuits, e.g., one or more single-core or multi-core microprocessors or microcontrollers, examples of which are known in the art. In operation, processing system 210 can control the operation of host device 202. In various embodiments, processing subsystem 210 can execute a variety of programs in response to program code and can maintain multiple concurrently executing programs or processes. At any given time, some or all of the program code to be executed can be resident in processing subsystem 210 and/or in storage media such as storage device 212.

Through suitable programming, processing subsystem 210 can provide various functionality for host device 202. For example, in some embodiments, processing subsystem 210 can implement some or all of control and routing logic 168 and/or host-side identification logic 174 of FIG. 1. Processing subsystem 210 can also execute other programs to control other functions of host device 202, including application programs that may be stored in storage device 212; in some embodiments, these application programs may interact with accessory 204, e.g., by generating messages to be sent to accessory 204 and/or receiving messages from accessory 204. Thus, for example, at different times (or concurrently) processing subsystem 210 can provide different virtual devices (e.g., apps 162, media player 164, and/or phone 166 of FIG. 1).

Network interface 216 can provide voice and/or data communication capability for host device 202. In some embodiments network interface 216 can include radio frequency (RF) transceiver components for accessing wireless voice and/or data networks (e.g., using cellular telephone technology, advanced data network technology such as 3G or EDGE, Wi-Fi (IEEE 802.11 family standards), or other mobile communication technologies, or any combination thereof), components for short-range wireless networking (e.g., using Bluetooth standards), GPS receiver components, and/or other components. In some embodiments network interface 216 can provide wired network connectivity (e.g., Ethernet) in addition to or instead of a wireless interface. Network interface 216 can be implemented using a combination of hardware (e.g., driver circuits, antennas, modulators/demodulators, encoders/decoders, and other analog and/or digital signal processing circuits) and software components.

Accessory I/O interface 218 can allow host device 202 to communicate with various accessories such as accessory 204. For example, accessory I/O interface 218 can support connections to a computer, an external keyboard, a speaker dock or media playback station, a digital camera, a radio tuner, an in-vehicle entertainment system or head unit, a home control system, an external video device, a memory card reader, and so on. In some embodiments, accessory I/O interface 218 can include a connector, such as connectors corresponding to the connectors used in various iPod®, iPhone®, and iPad® products, as well as supporting circuitry. The connector can provide connections for power and ground as well as for one or more data communication interfaces such as Universal Serial Bus (USB), FireWire (IEEE 1394 standard), and/or universal asynchronous receiver/transmitter (UART). In some embodiments, the connector provides dedicated power and ground contacts, as well as some number (e.g., four) of programmable digital data contacts that can be used to implement different communication technologies in parallel; for instance, two pins can be assigned as USB data pins (D+ and D−) and two other pins can be assigned as serial transmit/receive pins (e.g., implementing a UART interface); the assignment of pins to particular communication technologies can be negotiated while the connection is being established. In some embodiments, the connector can also provide connections for audio and/or video signals, which may be transmitted to or from host device 202 in analog and/or digital formats. Thus, accessory I/O interface 218 can support multiple communication channels, and a given accessory can use any or all of these channels. In some embodiments, accessory I/O interface 218 can support wireless communication (e.g., via Wi-Fi, Bluetooth, or other wireless protocols) in addition to or instead of wired communication channels.

Accessory 204 (e.g., implementing accessory 102 of FIG. 1) can include controller 230, user interface device 232, accessory-specific hardware 234, host I/O interface 236, and authentication module 238. Accessory 204 is representative of a broad class of accessories that can interoperate with a host device, and such accessories can vary widely in capability, complexity, and form factor. Various accessories may include components not explicitly shown in FIG. 2, including but not limited to storage devices (disk, flash memory, etc.) with fixed or removable storage media; video screens, speakers, or ports for connecting to external audio/video devices; camera components such as lenses, image sensors, and controls for same (e.g., aperture, zoom, exposure time, frame rate, etc.); microphones for recording audio (either alone or in connection with video recording); and so on. In addition, some accessories may provide an additional interface (not shown) that can connect to and communicate with another accessory.

Controller 230 can include, e.g., one or more single-core or multi-core microprocessors and/or microcontrollers executing program code to perform various functions associated with accessory 204. For example, where accessory 230 incorporates a user-operable control (e.g., controls 122 of FIG. 1), controller 230 can interpret user operation of the control and responsively invoke functionality of accessory 204; in some instances, the invoked functionality can include sending messages to and/or receiving messages from host device 202. As another example, controller 220 can implement some or all of accessory-side identification logic 170 of FIG. 1.

User interface 232 may include user-operable input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital-to-analog or analog-to-digital converters, signal processors, or the like). Depending on the implementation of a particular accessory 204, a user can operate input devices of user interface 232 to invoke functionality of accessory 204.

Accessory-specific hardware 234 can include any other components that may be present in accessory 204 to enable its functionality. For example, in various embodiments accessory-specific hardware 234 can include one or more storage devices using fixed or removable storage media; GPS receiver; a network interface; power supply and/or power management circuitry; environmental sensors (e.g., temperature sensor, pressure sensor, accelerometer, chemical sensor, etc.); and so on. It is to be understood that any type of accessory functionality can be supported by providing appropriate accessory-specific hardware 234.

Host I/O interface 236 can allow accessory 204 to communicate with host device 202. In accordance with some embodiments of the invention, host I/O interface 236 can include a connector that mates directly with a connector included in host device 202, such as a connector complementary to the connectors used in various iPod®, iPhone®, and iPad® products. Such a connector can be used to supply power to host device 202 and/or receive power from host device 202, to send and/or receive audio and/or video signals in analog and/or digital formats, and to communicate information using one or more data communication interfaces such as USB, UART, and/or FireWire. Other connectors may also be used; for example, host I/O interface 236 can incorporate a standard USB connector and can connect to accessory I/O interface 218 of host device 202 via an adapter cable. In other embodiments, host I/O interface 236 can support wireless communication (e.g., via Wi-Fi, Bluetooth, or other wireless protocols) in addition to or instead of wired communication channels.

Authentication module 238 can provide authentication information to host device 202, e.g., to verify the identity of accessory 204. For example, authentication module 238 can store a digital certificate that can be provided to host device 202 when a connection is established between host I/O interface 236 and accessory I/O interface 218. Authentication module 238 can also include cryptographic logic. In some embodiments, to verify the identity of accessory 204, host device 202 can send a random nonce (e.g., a randomly generated character string) to be digitally signed (e.g., encoded) by accessory 204 using a private key, and authentication module 238 can store the private key as well as programmed or hardwired control logic to use the stored private key to sign the random nonce. A variety of authentication mechanisms can be implemented.

Accessory 204 can be any electronic apparatus that interacts with host device 202. In some embodiments, accessory 204 can provide remote control over operations of host device 202, or a remote user interface that can include both input and output controls (e.g., a display screen to display current status information obtained from host device 202). Accessory 204 in various embodiments can control any function of host device 202 and can also receive data from host device 202. In other embodiments, host device 202 can control operations of accessory 204, such as retrieving stored data from a storage medium of accessory 204, initiating an image capture operation by a camera incorporated into accessory 204, etc.

It will be appreciated that the system configurations and components described herein are illustrative and that variations and modifications are possible. The host device and/or accessory may have other capabilities not specifically described herein (e.g., mobile phone, global positioning system (GPS), broadband data communication, Internet connectivity, etc.). Depending on implementation, the devices can interoperate to provide any functionality supported by either (or both) devices or to provide functionality that is partly implemented in each device. In some embodiments, a host device can have some functionality that is not accessible or invocable via an accessory device; likewise, an accessory device can have some functionality that is not accessible or invocable via a host.

Connectors at the respective I/O interfaces 218, 236 of host device 202 and accessory 204 can be complementary or not as desired. Where two connectors are not complementary, an adapter (not shown) can be provided to connect the two devices. While connectors may be described herein as having pins, a term generally associated with conventional electronic devices having wires to connect components, it is to be understood that other signal paths (e.g., optical signaling) can be substituted. Further, in some embodiments, some of the connections can be wireless, and connectors can be omitted where wireless interfaces are provided.

Further, while the host device and accessory are described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Accessory I/O interface 218 of host device 202 and host I/O interface 236 of accessory 204 include interfaces that allow host device 202 to be connected with accessory 204 and subsequently disconnected from accessory 204. As used herein, a host device and an accessory are “connected” whenever a communication channel is established between their respective interfaces and “disconnected” when the channel is terminated. Such connection can be achieved via direct physical connection, e.g., with mating connectors; indirect physical connection, e.g., via a cable; and/or wireless connection, e.g., via Bluetooth.

In some embodiments, a host device and an accessory can communicate while connected by exchanging messages and data according to an “accessory protocol.” The messages and data can be communicated, e.g., using any wired or wireless transport medium provided by the relevant interfaces.

The accessory protocol can define a “universe” of messages that can be exchanged between host device 202 and any accessories connected thereto, such as accessory 204. The message format can include, e.g., a start bit or bit sequence to indicate that what follows is a message code, followed by an actual message code that can be interpreted and acted on by the recipient. At least some of the message codes may have one or more associated parameters defined by the protocol, and a message can include values for any such parameters in addition to the message code. In some instances, the protocol can further specify a behavior for a recipient in the event that a particular parameter associated with a message code is not received or in the event that an unexpected parameter is received with a message code. The number of parameters can be different for different messages, and in some instances, a parameter may have variable length. In some embodiments, the message codes can be defined such that a given message code is valid in only one direction. Other message structures can also be used.

The accessory protocol can also define a format for the exchange of messages. For instance, the accessory protocol may specify that a message is sent using one or more packets, each of which has a header and a payload. The header provides basic information (e.g., a start indicator; length of the packet; packet sequence number; identifier of a session with which the packet is associated, as described below), while the payload provides all or part of the message data. The packet can also include error-detection or error-correction codes as known in the art.

In some embodiments, the messages can be logically grouped into a “general” message set and an “optional” message set. Every accessory and every host device that use the accessory protocol can be required to support at least the general message set. This message set can include messages enabling the host device and the accessory to identify and authenticate themselves to each other, to provide information about their components and/or interfaces, and to negotiate the functionality that they will mutually support. The general message set can also include authentication messages that the host device can use to verify the purported identity and capabilities of the accessory (or vice versa), and the accessory (or host device) may be blocked from invoking certain (or all) of the optional messages if the authentication is unsuccessful.

The optional message set can include messages related to various functionality that might or might not be supported by a given accessory. For example, the optional message set can include simple remote messages that allow an accessory to identify a function of the host device to be invoked, remote user interface messages that can be used to obtain information related to replicating all or part of a user interface of a host device on an accessory (thereby supporting a more advanced remote control), messages that allow a user to control a radio tuner in an accessory by operating a host device and/or to control a radio tuner in a host device by operating an accessory, messages that facilitate transfers of data objects between the host device and the accessory, and so on. Any combination of optional messages can be defined in an accessory protocol, and there is no requirement that a given accessory or host device support all (or even any) of the optional messages.

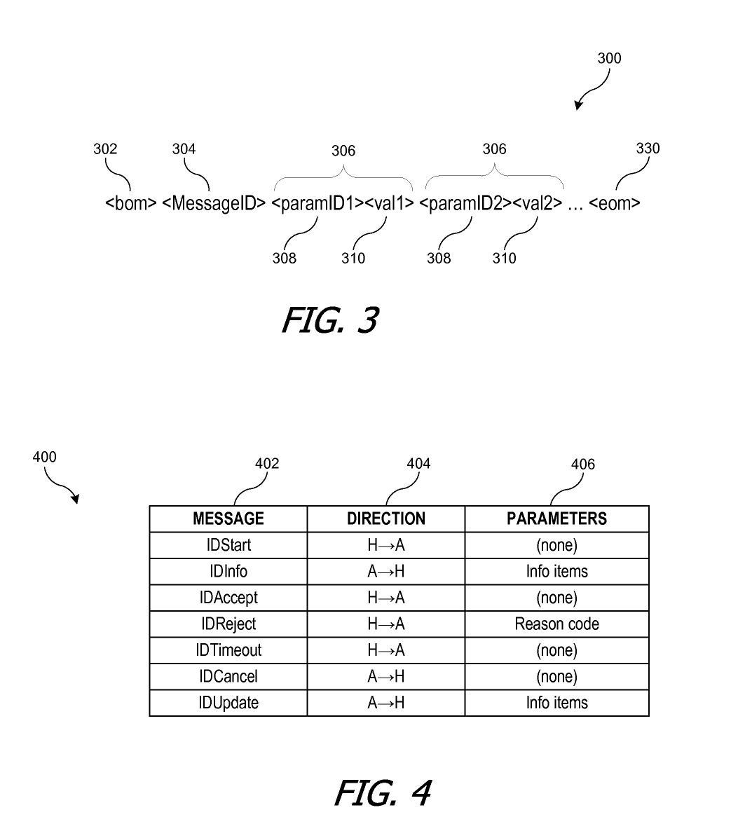

FIG. 3 illustrates a format for a message 300 that can be implemented according to an embodiment of the present invention for some or all of the messages defined in the accessory protocol. Each message 300 can begin with a beginning-of-message (“BOM”) flag 302. BOM flag 302 can be, e.g., a particular byte code, character, or character sequence used to indicate that what follows is a message A message identifier (MessageID) 304 can follow BOM flag 302; this identifier indicates which message is being sent. In some embodiments, all message identifiers have the same length (L_{M}), which can be, e.g., 1 byte or 2 bytes, depending on the total number of messages the protocol is to support.

Following the message ID 304 can be zero or more parameter/value pairs 306 associated with the message ID. Different message IDs may have different numbers of associated parameters (including zero parameters for some message IDs), and depending on implementation, some or all of the parameters associated with a particular message ID may be optional. To allow for flexibility, each parameter/value pair can include an explicit parameter identifier (paramID) 308, followed immediately by a value 310 for that parameter. The parameter IDs can be fixed length (e.g., 1 byte) for all parameters, with a different ID assigned to each parameter associated with a particular message ID. The length of value 310 can depend on the parameter ID. Examples of parameter IDs and values associated with identification and negotiating interoperating capabilities are described below. After the last parameter/value pair 306, message 300 can end, e.g., with an end-of-message (“EOM”) flag 330. Like BOM flag 302, EOM flag 330 can be, e.g., a particular byte, byte code, character or character sequence. EOM flag 330 can be a distinct value from BOM flag 302 and distinct from any byte code associated with a parameter ID.

In some embodiments, every message conforming to the accessory protocol uses the format of message 300, including messages sent by both devices. The recipient of message 300 can parse the message by recognizing BOM flag 302, interpreting the next L_{M} bytes as message ID 304, then interpreting each included parameter/value pair 306 based on the message ID. Thus, for example, a paramID of 6 in association with a message ID for a “set video resolution” message can signify that the associated value indicates a screen size in pixels, while a parameter ID of 6 in association with a “set audio sampling rate” message signifies that the associated value indicates a number of samples per second.

As noted above, the length of the parameter value can depend on the parameter ID. A recipient parsing a received message can read parameter ID 308, determine the expected length (L_{V}) of the associated value (e.g., in bytes), and accordingly interpret the next L_{V} bytes as the value. The following byte can be interpreted as the next parameter value, unless it corresponds to the byte code assigned to EOM flag 330, in which case the message is regarded as complete.

The use of explicit parameter/value pairs (rather than, e.g., assuming a parameter order) provides flexibility. For example, some or all of the parameters associated with a particular message ID 304 can be assigned a default value, and the sender can omit from message 300 any parameters for which the default value is to be used. This can reduce message length. In addition, as the protocol develops over time (e.g., to accommodate new devices and/or new functionalities), new parameters can be added to a message. Forward and backward compatibility can be maintained as long as default values are defined for any new parameters that are added to a message after its initial definition is established. Even if a device does not send a particular parameter (e.g., because it implements an older version of the protocol that predates the definition of the new parameter), the recipient can still parse the message and act appropriately. In some embodiments, the protocol can specify that if a device receives a message with a recognized message ID but an unrecognized parameter ID, the device should ignore the unrecognized parameter. This can allow a device implementing an older version of the protocol to interoperate with a newer device, without either device having to negotiate version-specific differences.

As described above, messages 300 can include messages related to identification of an accessory to a host device (and/or vice versa) and to negotiating the functionality the devices will cooperatively implement (also referred to herein as an operating agreement). FIG. 4 is a table 400 showing identification messages according to an embodiment of the present invention. For each message in column 402, a valid direction (host to accessory or accessory to host) is indicated in column 404; column 406 describes parameters that can be included with each message.

An IDStart message can be sent by a host to an accessory to initiate an identification process. The IDStart message in this example includes no parameters; it merely indicates that the host is ready to receive an identification message from the accessory. In some embodiments, the IDStart message can include parameters providing basic information about the host device (e.g., manufacturer and model identifiers, firmware version, or the like). In some embodiments, separate messages (not shown) can be sent by the host to provide host-identifying information to the accessory.

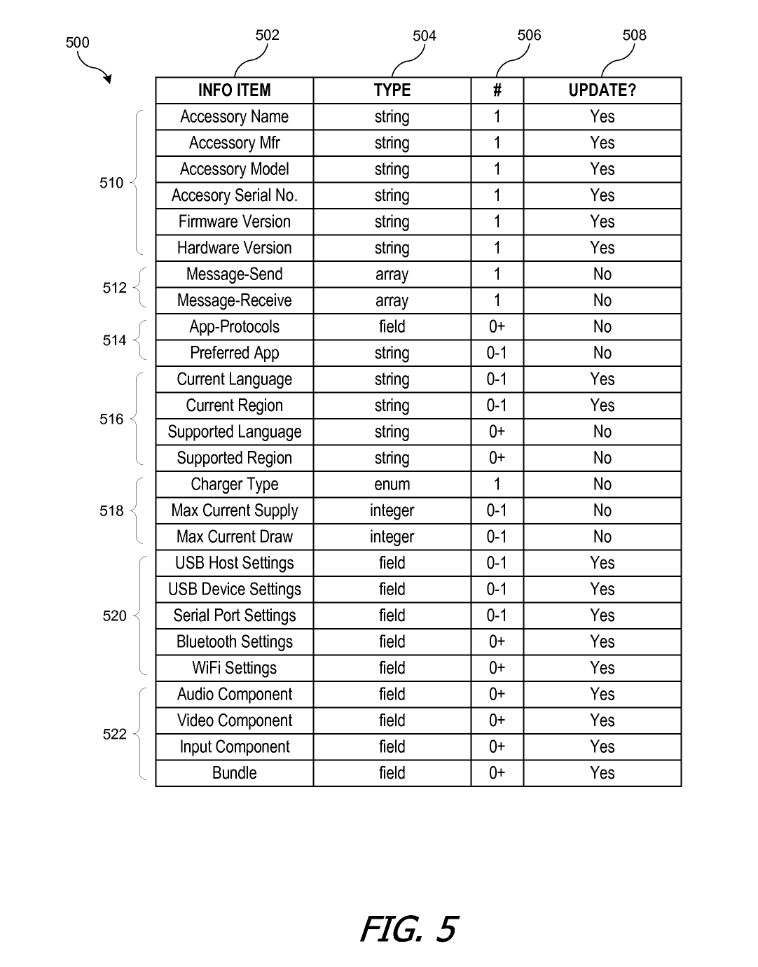

An IDInfo message can be sent by the accessory to the host to provide an identification proposal. The IDInfo message can include as parameters a number of “info items,” each of which can have an associated value. Specific examples are described below with reference to FIG. 5. In some embodiments, a single IDInfo message can include all of the identifying information about the accessory, including manufacturer and model information; a list of accessory-protocol messages the accessory proposes to be allowed to send and/or receive; information identifying applications with which the accessory can interact; information about settings and preferences of the accessory; information about power supply and/or power consumption characteristics of the accessory; information about communication interfaces supported by the accessory (e.g., USB, UART or other serial ports, Bluetooth, Wi-Fi, other wireless transports); and information descriptive of particular components or groupings of components included in the accessory. Depending on implementation, the IDInfo command can provide the host with complete information about the accessory's components, capabilities and proposed functionality to any degree of detail desired. Accordingly, in some embodiments, an accessory can present a proposal for interoperation to the host by sending an IDInfo message.

An IDAccept message can be sent by the host to the accessory to indicate that a proposal (e.g., as communicated by an IDInfo message) is accepted; an IDReject message can be sent by the host to the accessory to indicate that a proposal has been rejected. In some embodiments, the host determines whether to accept or reject a proposal based on information in the IDInfo command and its own set of rules. Examples are described below.

An IDTimeout message can be sent by the host to the accessory to indicate a timeout condition. For example, if the host sends an IDStart message and the accessory does not respond with an IDInfo message within a set period of time, the host can send an IDTimeout message to indicate that future messages, including IDInfo messages, will not be accepted. In a situation where the accessory sends an IDInfo message but for some reason the host does not receive it, the IDTimeout message can alert the accessory to the problem; this message can prevent the accessory for waiting indefinitely for a response from the host.

An IDCancel message can be sent by the accessory to indicate that it does not intend to complete the identification process (which can include negotiation of an operating agreement). This message can be sent, e.g., after the accessory receives an IDReject message, if the accessory determines that it will not retry. In response to an IDCancel message, the host device can terminate the connection to the accessory or restart the identification, e.g., by sending a new IDStart message. In some embodiments, an accessory that has completed the identification process can send an IDCancel message at any time in order to re-identify itself, and the host can respond by sending a new IDStart message.

An IDUpdate message can be sent by the accessory to update an identification after it has been accepted. In some embodiments, the parameters that can be updated using an IDUpdate message can be restricted to a subset of parameters of the IDInfo message. Thus, for example, an accessory may be permitted to change its name, user-preference settings, or status of components or interfaces by sending an IDUpdate message but not permitted to change the list of messages it can send or receive or to add or remove components or interfaces. (Changes not permitted using IDUpdate can be made by sending IDCancel and reidentifying.)

As noted above, an IDInfo message can include all of the identifying information about the accessory. FIG. 5 is a table 500 listing examples of parameters that can be defined for an IDInfo message according to an embodiment of the present invention. Each parameter listed in column 502 has a parameter type (column 504) that determines its length and a valid number range (column 506) indicating the number of instances of the parameter that can be included in one IDInfo message. Update column 508 indicates, for each parameter, whether that parameter can also be included in an IDUpdate message. Any parameters that cannot be included in an IDUpdate message can be changed by the accessory, e.g., by sending an IDCancel message and a new IDInfo message.

A first group of parameters 510 includes parameters providing basic information about the accessory, e.g., its name, manufacturer, model, serial number, firmware version and hardware version. Each of these parameters can be defined as a “string” type with a fixed length (e.g., 32 characters). As indicated in column 506, in some embodiments, the accessory is required to supply exactly one value for each of these parameters. Accordingly, a host can reject an IDInfo message that fails to specify these parameters.

A second group of parameters 512 includes parameters identifying specific messages from the accessory protocol that the accessory proposes to be allowed to send and receive; such messages are referred to as being included in a proposed “operative” subset. In this example, separate parameters are used to specify messages the accessory can send (Message-Send List) and messages the accessory can receive (Message-Receive List). Each parameter can be defined as an “array” type, and each element of the array can be exactly the size L_{M} of a message code (e.g., 1 or 2 bytes); thus, the value for each parameter can be a list of the appropriate message codes. It is contemplated that the length of the list can vary, depending on the details of accessory functionality and protocol implementation (e.g., what communications use distinct messages versus using the same message with different parameter values).

To allow for lists of variable length, in some embodiments, the length of an array-type parameter value can be variable. For example, the array can begin with a size indicator, e.g., one or two bytes to indicate the number of elements in the array, followed by the elements of the array (in this case, the actual message codes for the messages to be sent or received). The size indicator can also indicate the size of each element (which can be the same for all elements), or the element size can be determined based on the parameter ID with which the array is associated. Based on the parameter ID, the recipient can recognize that what follows is an array, read the size indicator, then read each element of the array.

In the embodiment shown the accessory specifies exactly one list of messages to be sent and exactly one list of messages to be received. As described above, in some embodiments the universe of messages can be divided into a set of general messages and a set of optional messages, and the protocol can specify that the general messages are always included in the operative subset regardless of whether they are included in the accessory's lists. Thus, for example, identification-related messages (e.g., the messages listed in FIG. 4) can be included in the general message set, and the host can infer that the accessory supports these messages from the fact that the accessory responds to an IDStart message by sending an IDInfo message. In some embodiments, if the accessory does not intend to send any messages other than general messages, the accessory can send a message-list parameter with an empty array (e.g., an array containing one entry having a null value).

In some embodiments, information identifying messages to be sent and messages to be received can be presented in a single list or divided into multiple lists. In some embodiments, each message code is valid in only one direction, and no ambiguity results from presenting a single list. In some embodiments, some message codes can be valid in both directions, and the accessory can indicate whether it intends to send and/or receive a particular message, e.g., by appending a directional indicator to the message code or by providing separate lists of messages to be sent and received (e.g., as shown in FIG. 5).

The lists of messages that can be sent and/or received can be overinclusive. That is, the accessory need not actually send every message included in the Message-Send list or receive every message included in the Message-Received list. In some embodiments, the message lists (if accepted by the host) bind the accessory to the following operating agreement: (1) The accessory agrees not to send to the host any message that is not on the Message-Send list (with the exception of any messages that the protocol presumes to be sendable, such as the identification messages in FIG. 4), and the host can ignore any such messages the accessory sends. (2) The accessory does not expect to receive any message that is not on the Message-Received list. (3) Receipt by the accessory of any message that is on the Message-Received list will not cause the accessory to send an error message to the host.

A third group of parameters 514 includes parameters related to the accessory's interoperation with particular applications that might or might not be installed on a particular host device. For example, the IDInfo message can include a Preferred App parameter to specify an identifier of an application with which the accessory is designed to interoperate. The identifier can be a string, such as a name or a unique code assigned to the application (e.g., at an application store through which the application is distributed), and the host device can use the identifier to determine whether the application is installed. Some accessories may choose not to specify a particular application; accordingly, an IDInfo message can include either zero or one instances of a Preferred App parameter.

In addition or instead, the IDInfo message can include an App-Protocols parameter to provide information about the accessory's ability to support a particular application-specific protocol. (An application-specific protocol allows messages to be passed between the accessory and the application using the accessory protocol as a conduit, with the accessory protocol being agnostic as to the content of such messages.)

In this example, application-specific protocol information can be provided using a structured “field” type for the parameter value. In some embodiments, a field-type parameter value can be implemented as a group of fixed-length fields, with the field definitions and lengths of each field being fixed for a particular parameter. Alternatively, a field-type parameter value can be implemented much like the parameter list shown in FIG. 3, using key/value pairs, but within a single parameter rather than as separate parameters. In some embodiments, all key/value pairs defined for a field-type parameter are required to be included, to facilitate parsing. Whether a field-type parameter can be “nested” within a field-type parameter is a matter of design choice.

The field for an App-Protocol parameter can include, e.g., a fixed-length string containing a name of a supported application-specific protocol, a fixed-length integer providing an identification number for the application-specific protocol, and/or a byte code identifying an action to be taken depending on whether the host device has an installed application capable of using the identified protocol (e.g., if the application is not found, the host can be instructed to search for a suitable application in an application store, query the user as to whether a search should be made, or do nothing). In some instances, an accessory might not support application-specific protocols, and in some instances, an accessory might support more than one application-specific protocols; accordingly, an IDInfo message can include any number (zero or more) of instances of an App-Protocols parameter.

A fourth group of parameters 516 includes parameters related to the accessory's support for language-based and/or regional differences in operation. For example, a keyboard accessory may be able to support different character sets depending on language and/or region; an accessory that displays information may also be able to present the information in different languages or in the same language with regional variations (e.g., U.K. vs. U.S. spellings in the case of English). An accessory that is capable of supporting different languages and/or regions can use the Current Language and/or Current Region parameters to identify the currently-selected language and/or region, e.g., as a string containing a recognized name for the language or region. Since only one language and one region can be current at a given time, no more than one instance of either parameter can be included in an IDInfo message.

If the accessory supports multiple languages and/or multiple regions, the accessory can supply a list of supported languages and/or regions using the Supported Language and Supported Region parameters. Any number of instances of each parameter can be included, with the parameter value being a string containing a recognized name of a language or region. In some embodiments, the current language and region are presumed to be supported and do not need to be provided using both “current” and “supported” parameters.

A fifth group of parameters 518 includes parameters related to accessory power and power management. For example, the Charger Type parameter can indicate one of a set of enumerated power types, depending on whether and how the accessory provides power to the host. Types can include, for example, “passthrough” to indicate that the accessory draws power from an external source and passes at least some of that power to the host, “self-powered” to indicate that the accessory draws power from an internal source (e.g., its own battery, solar panel or the like) and can provide at least some of that power to the host; and “none” to indicate that the accessory does not provide power to the host. In some embodiments, the IDInfo command is required to include the Charger Type parameter with one of the enumerated options as a value.

The Max Current Supply parameter can be included in some embodiments to specify the maximum amount of current that the accessory can supply to the host. The current can be specified, e.g., as a fixed-length integer (e.g., 8-bit) representing the maximum current in milliamps (mA). In some embodiments, if the IDInfo command indicates that the Charger Type is “none,” the Max Current Supply parameter can be omitted. In addition, some embodiments may specify a default value that the host will assume for the Max Current Supply parameter for each Charger Type, and the IDInfo command can omit the Max Current Supply parameter if the default value is acceptable to the accessory.

The Max Current Draw parameter can be included in some embodiments to specify the maximum amount of current that the accessory will draw from the host. Again, the current can be specified, e.g., as a fixed-length integer (e.g., 8-bit) representing the maximum current (in mA). Some embodiments may specify a default value that the host will assume for the Max Current Draw parameter, and the IDInfo command can omit the Max Current Draw parameter if the default value is acceptable to the accessory. It is not required that the accessory actually draw the specified maximum current (or indeed any current) from the host at any time.

A sixth group of parameters 520 includes parameters related to each communication interface supported by the accessory. It is contemplated that every accessory should support at least one communication interface, but an accessory can have multiple interfaces, and depending on implementation, some accessories can use multiple interfaces to communicate with the same host device. Parameters 520 allow the accessory to provide descriptors for each available interface. In any given instance, an IDInfo command can include at least one instance of at least one of the parameters of this group and can include multiple parameters and/or multiple instances of one parameter depending on what interfaces are available.

For each interface, the field can include appropriate descriptive information. For example, for any interface, the field can include a numeric identifier to be associated with that interface, a name for that interface, and a bit to indicate whether that interface supports accessory-protocol communication. The descriptor for a particular of interface can also indicate other information specific to interfaces of that type. For instance, a USB Host Settings descriptor can include information about audio sample rate(s) supported by the accessory's USB host interface. A Bluetooth Settings descriptor can indicate a supported version or flavor of Bluetooth (e.g., Classic, Low Energy, Nordic), a MAC address for the Bluetooth interface, a pairing method to be used (e.g., PIN code or secure sample pairing), and a PIN code (if needed). More generally, the descriptor for a particular interface can include (e.g., as sub-fields) any information that the host would use to establish a connection on that interface.

A seventh group of parameters 522 includes descriptors related to the various user input/output components of the accessory. For instance, an Audio Component descriptor can provide information about an audio input/output device such as a speaker, speaker system, microphone, headphone jack or headset. A Video Component descriptor can provide information about a display device such as a video screen. An Input Component descriptor can provide information about a user input device such as a keyboard, keypad, joystick, trackball, touch pad, touchscreen, etc. A Bundle descriptor can define groups of components as a logical subsystem within the accessory.

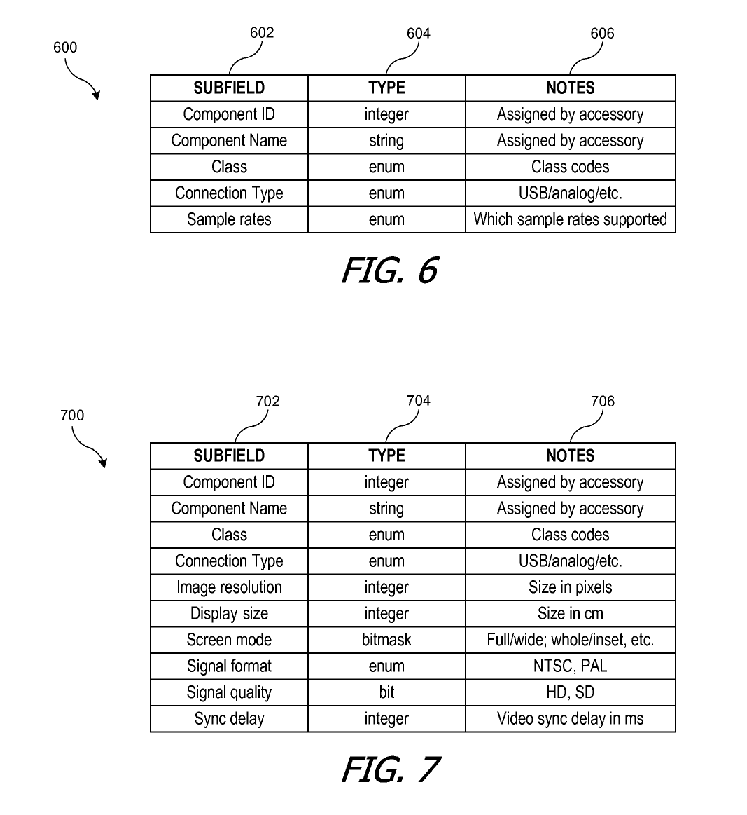

FIG. 6 is a table 600 illustrating subfields of an Audio Component descriptor according to an embodiment of the present invention. For each subfield (column 602), a type (column 604) and additional information (column 606) are indicated. The component ID can be an integer assigned by the accessory; it can be required that every component have a unique identifier. The component name can be a string used to associate a human-readable name with the component (e.g. “Front speakers,” “Rear speakers,” “Bluetooth headset”), and different components can have the same name.

The component class can be one of a number of predefined class types and can indicate to the host device certain aspects or characteristics of the audio component. For example, the set of defined class types for an audio component can include: desktop speaker (small environment, single user); home theater (multi-speaker, large environment); microphone (a component capable of providing audio signals generated from sound); instrument (a musical instrument or sound synthesizer capable of providing audio input); headset (speaker plus microphone for personal use); audio-video (a component capable of supplying or receiving video that is time-correlated with the audio, such as a camcorder or TV); telephone (a headset with its own connection to a telephone service independent of the host); converter (a component capable of changing the format of an audio signal); recorder (a component with the ability to capture and record sound independently of the host); and audio router (a component capable of selectively delivering audio to or from different endpoints within or connected to the accessory). Other class types can be defined in addition to or instead of these examples, e.g., front speakers and rear speakers in a vehicle can be differentiated.

The connection type can indicate which communication channels or interfaces can be used by the host to send audio to and/or receive audio from the component. Examples of connection types can include, e.g., analog (line-in/line-out); USB host-mode (where the accessory acts as the USB host); USB device-mode (where the accessory acts as the USB device). Connection types can be identified, e.g., by referring to the interface identifier assigned to one of the interface descriptors in parameter group 520. In some instances, a single connection type is provided in each Audio Component descriptor. Some embodiments allow multiple connection types to be identified for the same Audio Component, and the host device can dynamically select an audio routing path based on current operating conditions (e.g., which channels are currently open, how various channels are being used, etc.).

The sample rates subfield can be used to indicate one or more sample rates that the accessory supports. This information can be useful, e.g., if the host device determines a sample rate for providing or receiving audio. The host can limit its selection to a sample rate supported by the accessory, eliminating the need for the accessory to manage sample-rate conversions.

FIG. 7 is a table 700 illustrating subfields of a Video Component descriptor according to an embodiment of the present invention. For each subfield (column 702), a type (column 704) and additional information (column 706) are indicated. The component ID can be an integer assigned by the accessory; it can be required that every component have a unique identifier. The component name can be a string used to associate a human-readable name with the component (e.g. “TV,” “front console,” “rear console”), and different components can have the same name. Reuse of component names can be helpful, for example, if a user would logically think of two components as being a single device (e.g., a “TV” generally has both a display and speakers).

The component class can be one of a number of predefined class types and can indicate to the host device certain aspects or characteristics of the video component. For example, the set of defined class types for a video component can include: computer monitor (a display associated with a computer capable of operating independently of the host device); TV (a display capable of receiving television transmissions); portable display (a display with a small form factor adapted for carrying by a user); front vehicle console (display visible in the front seat of a vehicle); rear vehicle console (display located behind the front seat of a vehicle and not visible to a driver); camera (device capable of sourcing video); camcorder (device capable of recording video and audio, with at least a small screen for playback). Other class types can be defined in addition to or instead of these examples.

The connection type can indicate which communication channels or interfaces can be used by the host to send video to and/or receive video from the component being specified; this sub-field can be similar to the connection type sub-field of an Audio Component descriptor.

Additional subfields can be used to specify properties of the display. The display size can be specified in pixels and/or physical dimensions (e.g., centimeters or inches). A screen mode subfield can be used to indicate how the display will present images received from the host, e.g., whether the images will be presented in an inset (e.g., a window or other region within a larger display area) or full-screen. Screen mode can also indicate other characteristics such as whether the display operates in fullscreen (4:3 aspect ratio) or widescreen (16:9 aspect ratio) modes, or both. Signal format can indicate the type of video signal recognized by the display, e.g., NTSC or PAL. Signal quality can indicate whether the display is standard or high definition. Sync delay can provide information about the video latency of the display, to facilitate synchronizing audio with the video in the event that video and time-correlated audio are being delivered to different components.

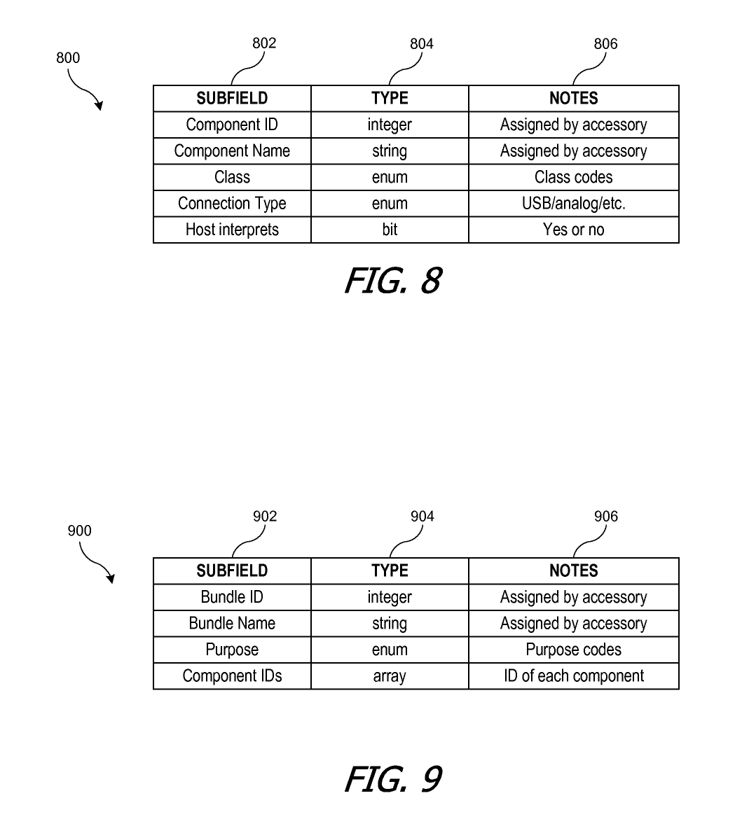

FIG. 8 is a table 800 illustrating subfields of an Input Component descriptor according to an embodiment of the present invention. For each subfield (column 802), a type (column 804) and additional information (column 806) are indicated. The component ID can be an integer assigned by the accessory; it can be required that every component have a unique identifier. The component name can be a string used to associate a human-readable name with the component (e.g. “keyboard,” “touchscreen,” “steering wheel controls”), and different components can have the same name. As noted above, reuse of component names can be helpful, for example, if a user would logically think of two components as being a single device.

The component class can be one of a number of predefined class types and can indicate to the host device certain aspects or characteristics of the input component. For example, the set of defined class types for an Input Component can include: keypad (10-key); keyboard (full alphanumeric keyboard); media controls (a device with controls to play, pause, select media assets, or the like); pointing device (mouse, trackball, pen); touch pad; touch screen; multitouch screen (touch screen that is capable of recognizing gestures based on touch and/or motion of one or more fingers); soft-key group (for a group of programmable buttons); knob; and wheel. Other class types can be defined in addition to or instead of these examples.

For each component class, additional subfields can be defined to provide information about the control that may help the host interpret signals received from the control. For example, in the case of a touch screen, the additional information can indicate the resolution of the touch-sensitive surface; in the case of a knob with detents, the additional information can indicate the number of detents. In the case of a soft-key group, the additional information can indicate the number and arrangement of buttons.

The connection type can indicate which communication channels or interfaces can be used by the host to receive input signals from the component being specified; this sub-field can be similar to the connection type sub-field of an Audio Component descriptor.

FIG. 9 is a table 900 illustrating subfields of a Bundle descriptor according to an embodiment of the present invention. For each subfield (column 902), a type (column 904) and additional information (column 906) are indicated. The bundle ID can be an integer assigned by the accessory; it can be required that every bundle defined by the accessory have a unique identifier. The bundle name can be a string used to associate a human-readable name with the bundle (e.g. “Front seat console,” “Rear seat console”).

A Purpose subfield can be used to indicate a purpose associated with a particular bundle. This “purpose” can represent a particular type of interaction that the bundle is intended to support (e.g., media playback, media recording, telephony). In operation, the host can use the purpose to select a bundle to be used during a particular interaction; examples are described below. As with the class codes for individual components, the purpose can be an enumerated type, with predefined types corresponding to any purpose that may be useful to identify to the host. In some embodiments, a purpose subfield can be included in a component descriptor in addition to or instead of a bundle descriptor.

The Bundle field can also identify each component to be included in the bundle, e.g., by providing an array of component identifiers that refer to the identifiers assigned to each included component (e.g., as shown in FIGS. 6-8). In some embodiments, each Bundle can also include one or more associated interfaces, e.g., by including an identifier assigned to one or more of the interface parameters in group 520 of FIG. 5. In some embodiments, multiple interfaces can be specified in each Bundle, in order of preference. When communicating with the accessory for the purpose associated with the Bundle, the host device can use the most preferred interface on which a communication channel is currently established.

It will be appreciated that the message formats, messages, and parameters described herein are illustrative and that variations and modifications are possible. Other parameters can also be defined for the IDInfo command, in addition to or instead of the examples shown above.

For example, the accessory can also provide information regarding other capabilities, such as navigation (e.g., using GPS or the like), environmental controls (e.g., the accessory's ability to control lighting, thermostat settings, etc.), or the like. Components and bundles can be associated with any of the accessory's capabilities.

In some embodiments, the IDInfo command can indicate by inference that the accessory has certain capabilities. For example, one or both of the message-list parameters may include messages pertaining to delivering GPS coordinates to and/or receiving GPS coordinates from the host device; from this, the host can infer that the accessory is capable of producing and/or consuming GPS information. As another example, the Messages-Send list can include a message requesting a video stream from the host device; from this, the host can infer that the accessory is capable of receiving a video stream.

Component and interface descriptors can be provided using the structured-field parameters described above or using other techniques. For example, rather than including all components in a single IDInfo message, an accessory can provide a sequence of messages, each message defining a component. (In such embodiments, the accessory can send an “ID complete” message after the last component-defining message so that the host can determine when all information has been received.) The accessory can limit the identification to components proposed to be used to interoperate with the host device, and identification can be further limited based on the extent to which the accessory processes or interprets signals sent to or received from the host. For example, if the accessory is capable of interpreting user-input signals from its own user input devices into messages conforming to the accessory protocol, the accessory need not provide details about its input controls. Similarly, if the accessory does not propose to present video streamed from the host device, the accessory need not provide information about any video display devices it may have.

The particular structure of component descriptors can be varied, and any structure can be used provided that component identification provides the host sufficient information to construct a logical model of the accessory as a set of input and/or output components (or groupings or bundles of such components), with each component (or bundle) being accessible via one or more interfaces. In some embodiments, different components (or bundles) within the same accessory can be associated with specific purposes, which can include particular functionalities of the host device with which the accessory can be used. The accessory protocol can define a set of recognized purposes based on functionality that is present in at least some host devices. As described below, the host device can use the component identification information to interpret input signals received from the accessory and/or to route output signals to the accessory via one or more available communication channels.

Embodiments described herein can provide robust and flexible techniques for identifying accessories to host devices and establishing an operating agreement between a host and an accessory. The identification process can be described as “holistic,” in the sense that the accessory delivers sufficient information about its capabilities, components and available communication interfaces to allow the host device to construct a logical model of the accessory as a set of components (or bundles of components), each of which is associated with particular functions or purposes and accessible via one or more particular communication interfaces. This in turn can allow the host device to determine optimal routing for signals exchanged with a particular accessory during the course of interoperation. To the extent that the component and bundle descriptors are defined in accessory firmware, the identification and routing optimization can be managed transparently to the user.

In addition, in embodiments where the identification also includes indications of the functionality the accessory intends to invoke (e.g., using the message lists described above), the host can also verify that the accessory has components capable of supporting the functionality it proposes to use. This can further facilitate smooth and reliable interoperation.

These techniques can be used, for example, in a context where a host is capable of interoperating with a number of different accessories having different capabilities to implement a broad range of accessory-dependent functionalities. Examples of identification processes and examples of interoperation based on identification results will now be described.

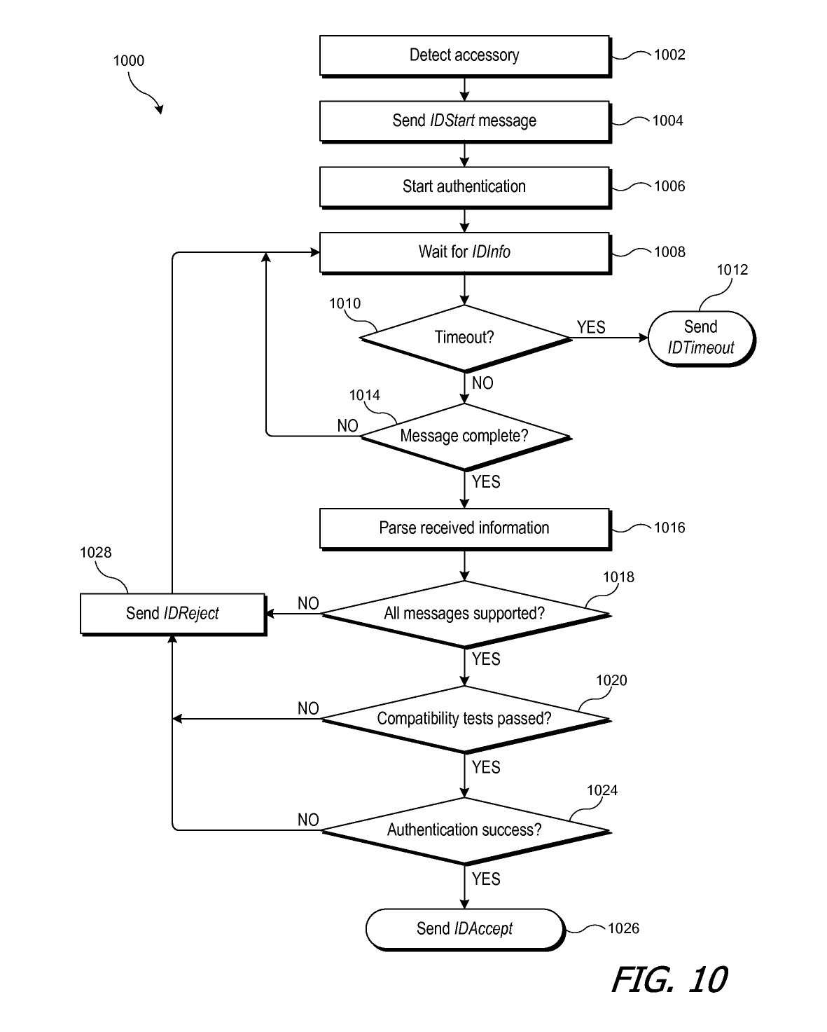

FIG. 10 is a flow diagram of a process 1000 for negotiating identification that can be implemented in a host device (e.g., host device 100 of FIG. 1 or host device 202 of FIG. 2) according to an embodiment of the present invention.

Process 1000 can begin at block 1002, when the host detects a connection to an accessory. For example, the accessory may be connected to a connector on the host device as shown in FIG. 1, and the connected accessory may pull one or more pins on the connector to particular voltages indicating the presence of the accessory. An accessory may also request a connection via a wireless protocol (e.g., Bluetooth or Wi-Fi), and the host can respond to establish a connection usable to exchange accessory-protocol messages.

At block 1004, the host can request that the accessory identify itself, e.g., by sending an IDStart message as described above. The host can also start an authentication process at block 1006 to verify authenticity of the accessory. In some embodiments, the authentication process can include requesting and receiving a digital certificate from the accessory, confirming the validity of the digital certificate (e.g., by comparing it to lists of known good and/or known bad certificates), and issuing a random nonce or challenge to the accessory for the accessory to digitally sign using a private key and return; the signed nonce can be verified by the host device using a public key associated with the digital certificate. The authentication requests and responses can be implemented, e.g., using messages in the general message set of the accessory protocol. (As with the identification messages, it can be assumed that all accessories and all hosts are capable of sending and receiving authentication messages, and failure of an accessory to respond properly or at all to an authentication message can be interpreted by the host as failure of the authentication process.) In some embodiments, the authentication process can run in the background while process 1000 continues with identification. In other embodiments, process 1000 can wait at block 1006 for authentication to complete and proceed further only if authentication is successful.

At block 1008, process 1000 can wait for an IDInfo message from the accessory. In some embodiments, the host does not wait indefinitely. For example, at block 1010, process 1000 can determine whether a timeout period has elapsed since the IDStart message was sent. The period can be, e.g., 100 milliseconds, 2 seconds, or any other desired time period. If the timeout period has elapsed, then at block 1012, process 1000 can exit, sending an IDTimeout message as described above to the accessory. To re-attempt identification after a timeout, the accessory can reestablish the connection, thereby restarting process 1000 at block 1002.

Depending on implementation, reestablishing the connection might or might not require physical disconnection and reconnection of the devices or other user intervention (e.g., pressing a reset button on the accessory). In some embodiments, the host does not have a timeout period, and process 1000 can wait for an IDInfo message for as long as the accessory remains connected.

If, at block 1010, the timeout period has not elapsed, then at block 1014, process 1000 can determine whether a complete IDInfo message has been received. In some embodiments, a single IDInfo message can be split across multiple packets for transport to the host, and it is possible that at some moment, only part of the IDInfo message has been received. If the message is not complete, process 1000 can continue to wait (block 1008) until either the complete message is received or a timeout occurs. (In some embodiments, receipt of a partial IDInfo message can reset the timeout interval, allowing the accessory more time to complete the message.). In some embodiments, an accessory can send multiple IDInfo messages, each containing a portion of the identifying information, and block 1014 can include detecting a different message (e.g., an “ID Complete” message) indicating that the accessory has finished sending IDInfo messages.

Once the complete IDInfo message has been received, at block 1016, the host device can parse the received information and determine whether to accept or reject it, e.g., by applying various decision rules. For example, at block 1018, the host device can read the list(s) of proposed operative messages (e.g., the Message-Send List and Message-Receive List parameters of FIG. 5) and determine whether the host is capable of receiving all the sendable messages and sending all the receivable messages. If the host is not so capable, then the identification can be rejected.

Similarly, at block 1020, the host can perform other compatibility tests based at least in part on the information provided by the accessory. For example, the manufacturer and model information and/or the component descriptors can be used to determine certain capabilities of the accessory, such as whether it can provide GPS coordinates or receive video. If the accessory includes a “send GPS coordinates” message in its Message-Send list but is not known to be capable of providing GPS coordinates, a compatibility test can be failed. Similarly if the accessory includes a “Video Request” message in its Message-Receive list but is not known to be capable of receiving video signals, another compatibility test can be failed. As another example, if the message list indicates that the accessory can request a video or audio stream but the accessory does not identify an interface with sufficient bandwidth to receive the stream, another compatibility test can be failed. In some embodiments, the test can based on whether the accessory is known to be incapable of doing something its message list implies it can do, rather than on known capabilities.

In some embodiments, rather than relying on explicit information about a particular accessory's capabilities (or lack thereof), the host device can infer from the messages list that the accessory has certain capabilities. For example, if the accessory indicates that it can send a “Video Request” message, the host can infer that the accessory is capable of receiving video signals. In some embodiments, the optional message set can include a group of messages that are needed to negotiate a video signal format to be delivered to the accessory and to control (e.g., start and stop) a video feed, and the host can require that the accessory supports either the entire group or none of these messages.

In some embodiments, a particular host device may be known to be incompatible with a particular accessory model, and this known incompatibility can also be the basis for failure of a compatibility test.

A compatibility test can also be defined to enforce user expectations regarding device behavior. For example, if a user can interact with a particular accessory to define a playlist of media assets stored on the host device (e.g., by invoking smart playlist functionality or operating a remote interface provided by the accessory to select assets from the host's media asset database), the user may reasonably expect to be able to interact with the same accessory to play such a playlist. Accordingly, a test can be defined that is failed if the accessory's list of proposed operative messages includes messages related to defining a playlist on the accessory but does not include messages related to playing such a playlist.

At block 1024, the host can determine whether the authentication process begun at block 1006 succeeded. For example, success can require that the accessory present a known good certificate (or a certificate not on a known-bad list) and successfully sign the random nonce. Success can also require that the particular certificate be valid for the particular accessory, e.g., based on the accessory model number and/or the messages the accessory has included in the list of proposed operative messages. Other conditions can also be imposed to determine whether authentication is successful.

If all of the tests at blocks 1018, 1020, and 1024 passed, then at block 1026, process 1000 can accept the identification, e.g., sending an IDAccept message as described above. Process 1000 can exit at this point, with identification complete. It is to be understood that the host and the accessory can remain connected and can begin to interoperate according to the negotiated operating agreement, e.g., using any or all of the components, interfaces, and operative messages in the proposal the host accepted at block 1026. This can include messages in the Message-Send and/or Message-Receive lists described above, as well as any messages that are considered operative by default (e.g., general messages as described above).

If any of the tests at blocks 1018, 1020 or 1024 failed, then, at block 1028, the host can reject the identification, e.g., by sending an IDReject message. In some embodiments, the IDReject message can include a reason code indicating why the identification was rejected. For example, different reason codes can be assigned to indicate specific failure conditions, such as authentication failure, inability of the host to receive at least one message on the Message-Send list, inability of the host to send at least one message on the Message-Receive list, incompatibility of one or more messages with identified or inferred accessory characteristics, insufficiency of the set of messages to support an associated functionality, etc. In some embodiments, where a particular message or lack of a particular component descriptor led to the rejection, the reason code can also include information identifying the problematic message or missing component descriptor. Such information can facilitate a retry attempt by the accessory but is not required.

After sending an IDReject message, process 1000 can return to block 1008, allowing the accessory to retry the identification with a new IDInfo message. In some embodiments, if the identification is rejected because of authentication failure, process 1000 can exit rather than permitting the accessory to retry.

In the example shown, process 1000 does not limit the number of retries by an accessory. In some embodiments, process 1000 can impose a limit, e.g., by incrementing a retry counter each time block 1028 is executed and exiting rather than returning to block 1008 if the counter reaches an upper limit (e.g., 3 tries). In some embodiments, process 1000 can limit retries by implementing a “global timeout” that limits the time that can elapse between the first time process 1000 sends an ID Start message and the time a proposed identification is accepted; if no operating agreement has been established at the end of the global timeout period, process 1000 can exit. If process 1000 exits due to excessive retries (including expiration of a global timeout and/or exceeding a limit on number of retries), the accessory can still continue to attempt to identify, but as at block 1012, a disconnect/reconnect sequence can be required.

In some embodiments, an accessory can cancel an identification process at any point during process 1000, e.g., by sending an ID Cancel message as described above. If a cancellation message is received at the host while process 1000 is being executed, process 1000 can exit. At that point, there is no operating agreement in place between the host and the accessory, and the host can lock out (e.g., by ignoring) further communication from the accessory. To resume, the accessory can be required to disconnect and reconnect as described above, thereby restarting process 1000 at block 1002.

If a cancellation message is received after successful completion of process 1000 (e.g., subsequently to block 1026), the host can restart process 1000 to obtain new identification information from the accessory, e.g., without a disconnect/reconnect sequence. In this circumstance, some embodiments may not require reauthentication (e.g., blocks 1006 and 1024 can be omitted), as long as the host and the accessory remain connected.

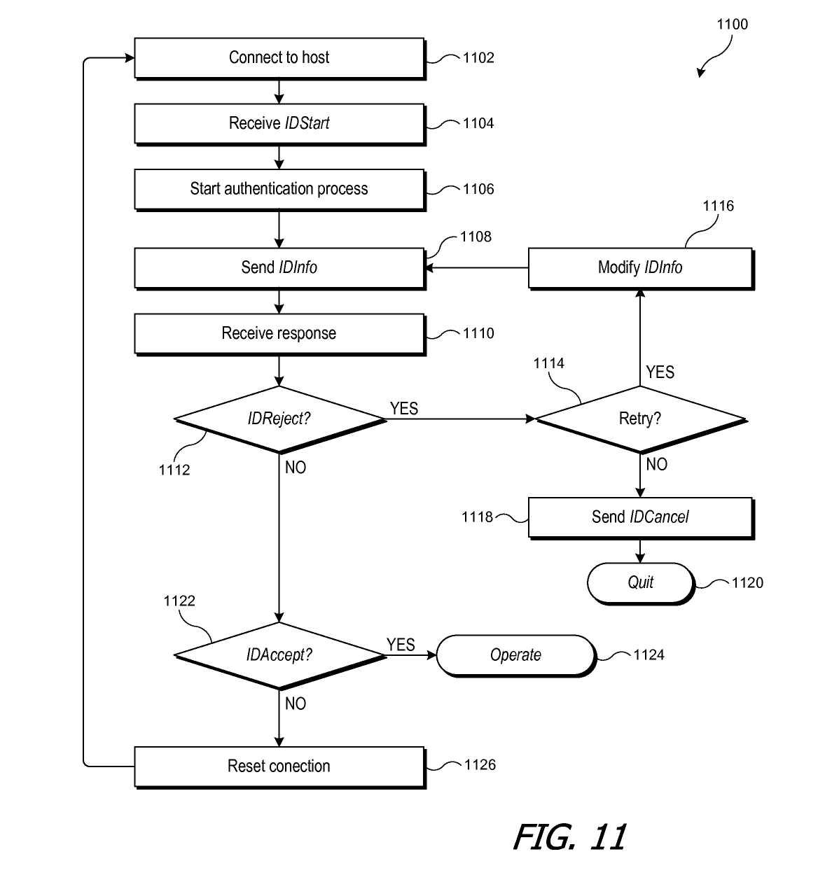

FIG. 11 is a flow diagram of an identification process 1100 that can be implemented in an accessory (e.g., accessory 102 of FIG. 1 or accessory 204 of FIG. 2) according to an embodiment of the present invention. Process 1100 begins at block 1102, when the accessory establishes a connection to the host. For example, a connector on the accessory can become engaged with a mating connector on the host (e.g., as shown in FIG. 1), or the accessory can locate a host using a wireless communication protocol and recognize the host as a device capable of communicating via the accessory protocol. Regardless of the details of the communication channel, block 1102 can include an operation by which the accessory alerts the host to its presence and readiness to use the accessory protocol to communicate.

At block 1104, the accessory can receive an ID Start message from the host, e.g., as described above. At block 1106, the accessory can initiate an authentication process with the host; this process can be complementary to the process initiated at block 1006 of process 1000 described above. As with process 1000, authentication at block 1106 can be performed in the background concurrently with other operations of process 1100, or process 1100 can wait at block 1106 until authentication is complete and proceed further only in response to successful authentication.

At block 1108, the accessory can send an IDInfo message to the host; the IDInfo message can include the accessory's proposal for a list of operative messages and descriptors of its components and interfaces. In some embodiments, the accessory can have a prepared IDInfo message that is automatically sent in response to an IDStart message. In some embodiments, the accessory can create or modify the IDInfo message in real time. For example, if the IDStart message (or some other preliminary message or signal received from the host) provides information about the particular host or its capabilities, the accessory can modify its list(s) of operative messages based on that information, e.g., to remove messages known not to be supported by the particular host or to select operative messages that will optimize the accessory's interoperation based on the characteristics of the particular host. As another example, the accessory can include or omit certain component or interface descriptors based on information about the particular host to which it is connected.

At block 1110, the accessory can receive a response from the host to the IDInfo message. In the embodiment shown, valid responses are IDAccept and IDReject. If, at block 1112, IDReject is received, then at block 1114, the accessory can determine whether to retry the identification. The determination can be based on various decision criteria, such as how many times the accessory has already tried or retried and failed, whether any fallback options (described below) are left, and/or what if any reason code was provided in the IDReject message.

If the decision is to retry, then at block 1116, the accessory can modify the IDInfo message. Various strategies can be implemented for modifying the IDInfo message when retrying. For example, the accessory can have one or more prepared “fallback” options for identification arranged in order of decreasing preference. The first option (sent in the initial pass at block 1108) may provide an optimum operating experience; successive fallback options may increasingly depart from this optimum, e.g., by removing or reducing functionality or by replacing a more efficient set of operative messages with a less efficient set that can provide similar (if not identical) functionality. At block 1116, the accessory can select the next IDInfo message in the sequence of fallback options.

In embodiments where the IDReject message includes a reason code (e.g., as described above), the accessory can use that information in modifying the IDInfo message and/or in determining whether to retry at all. For example, if the reason code identified a particular message on the Message-Send or Message-Receive list as a reason for rejection, the accessory can remove the offending message, assuming acceptable functionality can still be provided (and if not, the accessory can determine not to retry at block 1114). Or if the reason code identified a particular component or interface (or lack of same) as a reason for rejection, the accessory can modify its component or interface descriptors and retry.

The modified IDInfo message can be sent at block 1108, and if another rejection is received, the accessory can determine again whether to retry at block 1114. If at any point, the accessory determines not to retry, process 1100 can send an IDCancel message at block 1118 and exit at block 1120. In some embodiments, IDCancel is not sent; as described above, the host-side identification can implement a timeout, and the lack of a response from the accessory within the timeout period can be interpreted as a cancellation. In some embodiments, after exiting process 1100, the accessory can disconnect from and reconnect to the host in order to restart process 1100 and try again.

If, at block 1112, the IDInfo command is not rejected, then it is expected that the accessory receives IDAccept at block 1122. In that case, identification is successfully completed, and the accessory can begin to interoperate with the host at block 1124. Although process 1100 can exit, the accessory and the host can remain connected and can begin to interoperate according to the negotiated operating agreement, e.g., using any or all of the components, interfaces, and operative messages in the proposal the host accepted at block 1122. This can include messages in the Message-Send and/or Message-Receive lists described above, as well as any messages that are considered operative by default (e.g., general messages as described above).

In process 1100, if the accessory receives neither IDAccept nor IDReject in response to an IDInfo message, this is regarded as an error. (This can also occur in some embodiments if the host sends IDTimeout, either before or after the accessory sends IDInfo.) In this case, the connection can be reset at block 1126, and process 1100 can return to block 1102 to attempt to reestablish the connection and restart the identification process from the beginning Resetting the connection in some embodiments may require physical disconnection of the accessory from the host or other user intervention (e.g., pushing a reset button on the accessory). Block 1126 can be reached, for example, if the host does not respond at all within an accessory-determined timeout period or if the response is something other than IDAccept or IDReject.

It will be appreciated that the identification processes of FIGS. 10 and 11 are illustrative and that variations and modifications are possible. Steps described as sequential may be executed in parallel, order of steps may be varied, and steps may be modified, combined, added or omitted. For instance, the authentication process can be started at any time (including prior to the host sending IDStart to the accessory or after the host receives IDInfo) or omitted entirely if desired. Tests by the host to determine whether to accept or reject a particular identification proposal can be performed in any order, and any number and combination of tests can be used. In some instances, a test result can depend on both the content of the IDInfo message and the authentication information; for example, the ability to send or receive certain messages or use certain interfaces can be restricted based on the particular digital certificate presented by the accessory.

In instances where identification fails (e.g., a timeout occurs, or the accessory cancels), either the accessory or the host device (or both) can alert the user, depending on implementation.

Such alerts can take the form of on-screen notifications, lighting of indicator lights, sounds, etc. The user can then take appropriate action to resolve the failure, such as disconnecting and reconnecting the accessory (e.g., disengaging and reengaging connectors, pressing a reset button, or the like).

As described above, successful completion of identification operations (e.g., processes 1000 and 1100) places the host and accessory in a state where they are capable of exchanging messages and have negotiated an operating agreement that specifies which messages each device will accept from the other and which interfaces are available for communication with each other.

In some embodiments, as noted above, the accessory can send an IDUpdate message following successful completion of identification (e.g., processes 1000 and 1100). The IDUpdate message can include new values for one or more parameters that were previously specified using the IDInfo message. As described above, the IDUpdate message can be limited to updating a subset of the parameters in the IDInfo message (e.g., changing information about previously identified interfaces or components). To the extent that the IDUpdate message does not affect the existing operating agreement between the host and device, the host can simply update the relevant information and use the updated information to continue interacting with the accessory.

For example, in some embodiments, the accessory can provide its current language and/or region settings in the IDInfo message as described above. After identification, the host can reply with a message indicating recommended language and/or region settings that may be different from the current settings. (The recommendation can be based on the host device's own settings, on the accessory's current settings and supported languages/regions, on other information such as current location of the host device or the accessory, etc.) If the accessory accepts the recommendation, the accessory can send an IDUpdate message indicating the new current language and/or region setting. In another example, a user may change the language and/or region settings on the accessory by interacting directly with the accessory, and the accessory can send an IDUpdate message to inform the host of the change.

In some embodiments, updates to the accessory's interfaces and settings can be sent using IDUpdate messages. For example, the accessory may decide to activate an interface that was previously identified as not being available for accessory-protocol communication, or to deactivate a port that was previously identified as available. When the accessory activates an interface using IDUpdate, the host can apply the previously negotiated operating agreement to the newly activated interface. In some embodiments, the accessory cannot use an IDUpdate message to add an interface that was not identified using IDInfo but can use an IDUpdate to change settings related to any port that was identified using IDInfo.

If the accessory determines that changes to the operating agreement are needed, the accessory can send an IDCancel message rather than IDUpdate, then reidentify as described above. If the host determines that changes to the operating agreement are needed (e.g., in response to IDUpdate or any other event or occurrence), the host can send a new IDStart message, thereby reinvoking the identification processes.

Once identification is complete, the accessory and the host can interoperate according to the agreed-upon terms. For example, the host can use information obtained from the accessory in determining how to process input signals and/or how to route output signals.

In some embodiments, an accessory can be connected on multiple interfaces concurrently and can connect or disconnect different interfaces at different times. It can be useful for the host device to determine whether one accessory is connected on multiple interfaces or whether different accessories are connected on different interfaces.

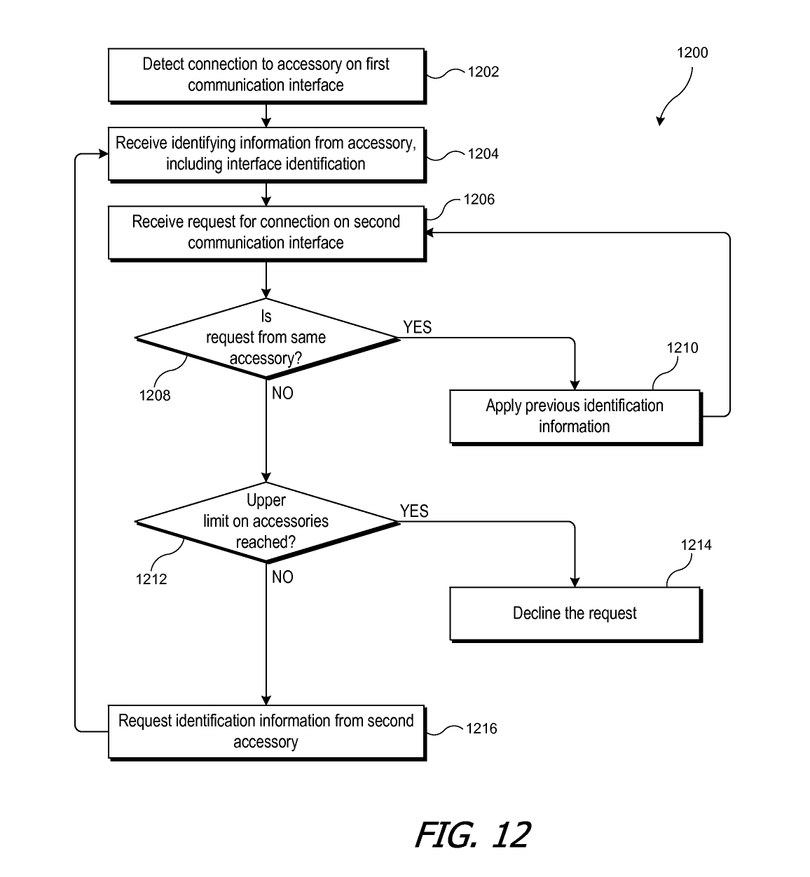

FIG. 12 is a flow diagram of a process 1200 for a host device (e.g., host device 100 of FIG. 1) that can manage multiple connections to one or more accessories according to an embodiment of the present invention. At block 1202, the host device can detect a connection to an accessory on a first interface. At block 1204, the accessory can identify itself to the host using the first interface. For example, processes 1000 and 1100 described above can be used. The identification can include information about all interfaces on which the accessory can connect to the host, even if connections have not yet been established on any other interfaces. At this point, the host device is connected to one “known” accessory.

At block 1206, while the known accessory remains connected on the first interface, the host device can detect a second connection to an “unknown” accessory (e.g., on a second interface). At block 1208, the host device can determine whether the unknown accessory is the known accessory or a different accessory. For example, in some embodiments, the host can use the accessory information received from the known accessory at block 1204. As described above, accessory identification can include providing information about each interface the known accessory is capable of using to communicate with the host device. This information can include a name and/or other identifier of the interface. If the second connection provides the same name and/or other identifier as was previously provided by the known accessory, the host device can detect the match and recognize that the “unknown” accessory is the same as the known accessory.

Alternatively, in some embodiments, the known accessory can send an accessory-protocol message via the first connection to indicate that it is establishing a second connection. For example, the accessory protocol can define an ActivateInterface message, with a parameter that includes the identifier or name of the interface via which a new connection is being established. (This identifier would have been provided to the host during identification at block 1204.) The accessory can send the ActivateInterface message via the first connection within a prescribed time interval before or after establishing the second connection. If the host detects a second connection and an ActivateInterface message identifying the same interface as the second connection within the prescribed time interval of each other, the host can determine that the second connection is another connection to the known accessory. If a second connection is detected without an ActivateInterface message being received within the prescribed time interval, the host can determine that the second connection is a connection to a different accessory. Other techniques can also be used.

If the host determines that the accessory on the second connection is the known accessory, then at block 1210, the host can apply the accessory-identifying information from block 1204 and communicate with the accessory using the first and second connections in any combination. For example, as described below, information can be selectively routed to one connection or the other based on type of information and/or purposes associated with different connections.

If, at block 1208, the host determines that the accessory on the second connection is not the known accessory, then at block 1212, the host can determine whether an upper limit on the number of concurrently connected accessories has been reached. This upper limit can be established in the host firmware and can be, e.g., one accessory, two accessories, or any other number. The particular upper limit is a matter of design choice and may be influenced by considerations such as the processing capabilities of the host device, available communication bandwidth across various channels, power consumption associated with maintaining connections to multiple accessories, and so on. If the upper limit has been reached, then at block 1214, the host device can decline the connection, e.g., by sending a message to the second accessory indicating refusal or by disconnecting the second connection. If the upper limit has not been reached, then at block 1216, the host device can request that the second accessory identify itself.

Process 1200 can be iterated to allow additional connections to be established, either to the same accessory or to multiple accessories. In some embodiments, there can be an upper limit on the number of concurrent connections to a single accessory (in addition to the upper limit on the number of connected accessories), and the host device can refuse additional connections to a single accessory if this limit is reached. In some embodiments, as long as at least one connection to the accessory remains connected, the accessory (or the host) can initiate or terminate connections (including the first connection) dynamically without requiring the accessory to re-identify; the accessory is required to re-identify only if a point in time occurs at which no connections to the accessory exist.

It is not required that every connection supports the accessory protocol. In some embodiments, the first connection should support the accessory protocol in order to provide holistic identification using the processes described above. Subsequent connections, however, need not use the accessory protocol. Thus, for example, the first connection can be established using a serial port (e.g., UART), and during identification, the accessory can indicate that it has a Bluetooth interface. Thereafter, a second connection can be established using the Bluetooth interface. The host can determine that the second connection is to the same accessory (e.g., as described above) and can communicate Bluetooth-compliant information (e.g., Bluetooth audio) to the accessory using the Bluetooth connection. At the same time, the host can continue to use the accessory protocol to communicate via the first connection.

In some embodiments, the host can exploit the fact that it has two or more connections to the same accessory, e.g., by selecting the optimum interface for particular types of communications. For example, the host can use a UART connection to communicate short control messages, a Bluetooth connection to communicate voice data (e.g., phone calls), and a USB connection to communicate music or other high-quality audio data (which can benefit from the higher bandwidth of USB as compared to Bluetooth).

Similarly, the host can implement routing rules in which particular connection interfaces are favored for particular types of information transfers. For example, for audio data, high bandwidth may be preferred, and connection interfaces can be “ranked” in an order of preference from high bandwidth to low (e.g., USB, Wi-Fi, Bluetooth in that order). For short messages (e.g., accessory protocol messages), low-bandwidth connections may be preferred (e.g., UART over USB). When the host device begins to send data of a particular type to the accessory, the host device can choose the most preferred connection interface for that type of data that is currently connected to the accessory. Further, if a connection interface that the host is using becomes disconnected, the host can redirect information transfers to the next most preferred connection interface that is currently connected. Routing selection and re-routing can be made transparent to the user; the host can automatically choose a routing behavior based on current conditions (e.g., which connection or connections are available and/or what type of information is being transferred).

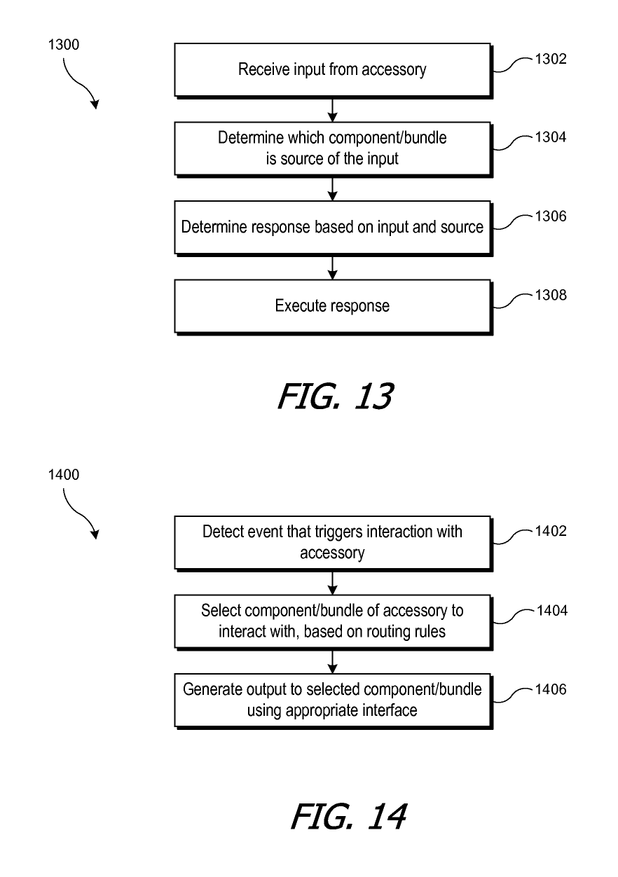

FIG. 13 is a flow diagram of a process 1300 usable by a host device (e.g., host device 100 of FIG. 1) to process input signals received from an accessory (e.g., accessory 102 of FIG. 1) according to an embodiment of the present invention. Process 1300 can occur, e.g., at any time following successful completion of identification processes 1000 and 1100 described above.

At block 1302, the host device receives an input signal from the accessory. This signal can be received via any communication channel on which the accessory is currently connected. (Signals requesting that a new channel be connected can be handled using a separate process, e.g., process 1200 described above.) At block 1304, the host device can determine which component (or bundle or group of components) within the accessory was the source of the input signal. For example, the host can determine which interface delivered the input signal, then identify a component or bundle associated with that interface as the source (e.g., based on the descriptors described above). As another example, the input signal itself can include the component ID or bundle ID of the source component or bundle; accordingly, different sources within the accessory can be distinguished even if they use the same communication channel or interface.

At block 1306, the host device can determine a response based on the input signal and the source. At block 1308, the host device can execute the response. As a result, the host device can respond differently depending on the source of a signal.

By way of illustration, consider the system of FIG. 1. Accessory 102 has several different components that can provide input to host 100. For example, rear-console controls 128 can include buttons or other controls to start, pause, resume, or stop playback of a media asset; adjust volume of rear speakers 116; browse a collection of media assets (e.g., assets stored in the database of host device 100); and so on. Steering wheel controls 130 can also include buttons or other controls related to playing media assets through front speakers 114, and front-console controls 122 can include controls related to playing media assets, making phone calls, and doing other operations.

Suppose that at a particular time, host device 100 is streaming audio content to rear speakers 116. Host device 100 can receive, as an input signal, a signal indicating a play/pause button event originating from rear-console controls 128. Based on the source, host device 100 can determine that the intent is to toggle the play/pause state of the audio content being delivered to rear speakers 116. Similarly, host device 100 can receive, as an input signal, a signal indicating a play/pause button event originating from steering-wheel controls 130. Host device 100 can determine a different action to take based on this signal. For example, host device 100 can interpret the signal as a request to begin streaming the same audio content to front speakers 114 and a subsequent input signal indicating a play/pause button event originating from steering wheel controls 130 as a request to stop streaming the audio content to front speakers 114. These operations can be performed without affecting the streaming to rear speakers 116.

As another example, host device 100 can perform modified versions of the same action, depending on the source of a particular input signal. For instance, if an input signal is received from steering-wheel controls 130 or front-console controls 122, host device 100 can assume that the driver is operating the controls and that the driver is not looking at display 104 of host device 102. Accordingly, host device 100 can keep its display 104 turned off even if the operation in question would normally involve turning on the display. If the input signal is received from rear-console controls 128, this assumption might not apply, and host device 100 can turn on its display.

Host device 100 can also use the accessory information to manage interactions (or changes in ongoing interactions) that are driven by events other than accessory input. FIG. 14 is a flow diagram of a process 1400 usable by a host device (e.g., host device 100 of FIG. 1) to interact with an accessory (e.g., accessory 102 of FIG. 1) according to an embodiment of the present invention. Like process 1300, process 1400 can occur, e.g., at any time following successful completion of identification processes 1000 and 1100 described above.

At block 1402, the host device can detect an event that triggers an interaction (or a change in an ongoing interaction) with an accessory. For example, the accessory may have requested to be notified when a particular event occurs, such as a change in location or motion of the host device, change in ambient lighting around the host device, an incoming telephone call or received e-mail or text message, or the like.

At block 1404, the host device can select a particular component (or bundle of components, as described above) of the accessory with which the interaction should be performed. In some embodiments, the selection is based on routing rules programmed into the host device, as applied to information about the components (or bundles) of the particular accessory to which the host is connected. The routing rules can associate particular events or categories of events with particular purposes and/or component classes (e.g., the purposes and component classes described above with reference to FIGS. 6-8).

For example, if the accessory has identified a component (or bundle) associated with the purpose of telephony, the host device can interact with that component (or bundle) in connection with telephone calls. Thus, if the event at block 1402 corresponds to detecting an incoming call, the host device can alert the telephony component of the accessory. As another example, if the event at block 1402 relates to streaming media (e.g., an end of the stream is reached or the host loses contact with a source of the stream), the host device can provide a notification of this event to a component (or bundle) of the accessory that is associated with playback of media content.

At block 1406, the host device can generate output to the component (or bundle) selected at block 1404, using the appropriate interface, which can be the interface associated with the component or bundle in the accessory-identification information previously provided to the host device (e.g., the descriptors described above). Interface selection can be based on information about what interfaces are currently connected (which can be known, e.g., by implementing process 1200 described above), preferred interfaces associated with a particular component (or bundle) as identified by the accessory, and/or preferred interfaces associated with a particular purpose as identified by the host device. As a result, the host can deliver information to the accessory or a particular component of the accessory via an interface appropriate to the purpose or intended use of the information.

While the invention has been described with respect to specific embodiments, one skilled in the art will recognize that numerous modifications are possible and that features described with specific reference to one embodiment can be applied in other embodiments. In some embodiments, not every accessory that can be connected to a host is required to identify itself; successful identification can be a condition of any further communication using the accessory protocol, but other (limited) functionality can be supported outside of the accessory protocol. For example, a charger may be able to provide power to the host device without sending any identification messages. As another example, the host device may have ports that do not implement the accessory protocol (e.g., an analog audio-out port such as a headphone jack), and identification might not be required for such ports.

In some embodiments, if a proposed identification is rejected, an accessory that chooses to retry is not required to resend all of its parameters (unless the accessory cancels the process or disconnects). The accessory can be required to resend complete message lists rather than amendments to previous lists, as well as any other parameters that the accessory determines should be changed. Requiring the accessory to present a single complete message list (or two separate lists, one for all messages sent and one for all messages received) can facilitate the host device's consideration of the revised proposal and can be simpler than implementing a series of instructions to remove individual messages from and/or add individual messages to a previously presented list.

In some embodiments, while identification is in progress, the accessory can be blocked from sending any messages not related to identification. For example, the host can ignore any such messages that may be received. In other embodiments, the host can provisionally allow at least some unrelated messages during the identification process (e.g., by receiving and acting on them) and begin to block or ignore messages after identification if the process ended in failure or if the messages are not within the scope of the negotiated operating agreement. Likewise, in some embodiments the accessory can choose whether to ignore or process messages unrelated to identification that may be received during the identification process.

Further, while the description above refers to an accessory identifying itself to a host device, those skilled in the art with access to the present teachings will recognize that the roles can be reversed. Similar messages and processes can be implemented to allow a host to identify itself holistically to an accessory. Bidirectional identification can also be implemented, e.g., with one device presenting information about itself and the other device responding with its own information. In any particular implementation, the negotiation of an acceptable set of messages to be exchanged can happen in either direction (e.g., either accessory proposes/host decides, as described above, or in the reverse direction, with host proposing and accessory deciding).

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method of identifying an accessory device to a host device, the method comprising:
establishing, by the accessory, a communication channel with the host device, wherein the communication channel is established using a first communication interface; and
sending, by the accessory, identification information to the host via the communication channel, wherein the identification information includes an interface descriptor of at least one other communication interface that the accessory is capable of using to communicate with the host.

2. The method of claim 1 wherein the identification information further includes a component descriptor of each of a plurality of components, the plurality of components including at least one of an audio output component, a video output component, or a user input component.

3. The method of claim 2 wherein the component descriptor of at least one of the plurality of components further includes a purpose indicator identifying a particular functionality with which the component is to be associated.

4. The method of claim 2 wherein the identification information further includes a bundle descriptor that associates at least some of the plurality of components into a bundle.

5. The method of claim 1 wherein the first communication interface is one of a Bluetooth interface, a UART interface, a USB interface, or a Wi-Fi interface.

6. The method of claim 1 wherein the at least one other communication interface includes at least one of a Bluetooth interface, a UART interface, a USB interface, or a Wi-Fi interface.

7. A method of communicating with an accessory by a host device, the method comprising:
detecting, by the host device, a connection to an accessory via a first communication channel, wherein the first communication channel uses a first communication interface;
receiving, by the host device via the first communication channel, identification information from the accessory, wherein the identification information includes an interface descriptor providing information about a second communication interface that the accessory is capable of using to communicate with the host;
determining, by the host device, whether to accept the identification information; and
in the event that the identification information is accepted, communicating, by the host device, with the accessory using the first communication interface and the second communication interface.

8. The method of claim 7 wherein the identifying information further includes an interface descriptor providing information about the first communication interface.

9. The method of claim 7 wherein communicating with the accessory using the first communication interface and the second communication interface includes:
determining, by the host device, that particular data is to be sent to the accessory;
selecting, by the host device, one of the first communication interface and the second communication interface for sending of the particular data; and
sending, by the host device, the particular data using the selected communication interface.

10. The method of claim 7 wherein communicating with the accessory using the first communication interface and the second communication interface includes:
receiving, from the accessory, an input signal via the first communication interface or the second communication interface;
determining, by the host device, an action to take in response to the input signal, wherein the determination is based in part on the input signal and in part on which one of the communication interfaces was used to deliver the input signal; and
taking, by the host device, the determined action.

11. A method for communicating with an accessory by a host device, the method comprising:
detecting, by the host device, a connection to a first accessory via a first communication channel, wherein the first communication channel uses a first communication interface;
receiving, by the host device via the first communication channel, identification information from the first accessory, wherein the identification information includes a plurality of descriptors of a plurality of communication interfaces that the first accessory is capable of using to communicate with the host, the plurality of communication interfaces including the first communication interface and a second communication interface;
detecting, by the host device, a connection request via the second communication interface;
determining, by the host device, whether the connection request was generated by the first accessory; and
in the event that the connection request was generated by the first accessory, communicating with the first accessory using the first communication interface and the second communication interface.

12. The method of claim 11 further comprising, in the event that the connection request was not generated by the first accessory:
determining, by the host device, whether a maximum number of accessories are currently connected; and
in the event that fewer than the maximum number of accessories are currently connected, requesting, by the host device, that the accessory using the second communication interface provide identification information.

13. The method of claim 11 wherein communicating with the first accessory using the first communication interface and the second communication interface includes:
determining, by the host device, that particular data is to be sent to the first accessory;
selecting, by the host device, one of the first communication interface or the second communication interface for sending of the particular data; and
sending, by the host device, the particular data using the selected one of the first communication interface or the second communication interface.

14. The method of claim 13 wherein the selection is based on respective bandwidth characteristics of the first and second communication interfaces.

15. The method of claim 11 wherein communicating with the first accessory using the first communication interface and the second communication interface includes:
receiving, from the accessory, a particular message via one of the first communication interface or the second communication interface;
determining, by the host device, an action to take in response to the particular message, wherein the determination is based in part on the particular message and in part on whether the message was received via the first communication interface or the second communication interface; and
taking, by the host device, the determined action.

16. An accessory device comprising:
a plurality of components including at least one of an audio component, a video component, or a user input component;
a plurality of communication interfaces operable to communicate with a host device; and
identification logic configured to send an identification message containing identification information to the host device via a first one of the plurality of communication interfaces,
wherein the identification information includes a component descriptor of each of the plurality of components and an interface descriptor of each of the plurality of communication interfaces.

17. The accessory device of claim 16 wherein the identification information further includes a bundle descriptor that associates two or more of the plurality of components with each other, thereby defining a bundle.

18. The accessory device of claim 17 wherein the bundle descriptor further associates at least one of the plurality of communication interfaces with the bundle.

19. The accessory device of claim 16 wherein the plurality of components includes a video component and the component descriptor of the video component includes information about video capabilities of the video component.

20. The accessory device of claim 16 wherein the plurality of components includes an audio component and the component descriptor of the audio component includes information about audio capabilities of the audio component.

21. A host device comprising:
execution logic configured to execute a plurality of functions;
a plurality of host communication interfaces operable to communicate with an accessory;
control and routing logic coupled between the execution logic and the plurality of host communication interfaces, the control and routing logic being configured to selectably route information from the execution logic to one of the plurality of host communication interfaces; and
identification logic configured to receive, from an accessory device via a first one of the plurality of host communication interfaces, an identification message containing identification information,
wherein the identification information includes a component descriptor of each of a plurality of accessory components and an interface descriptor of each of a plurality of accessory communication interfaces.

22. The host device of claim 21 wherein the control and routing logic is further configured such that a route for particular information from the execution logic to one of the host communication interfaces is determined based in part on the identification information.

23. The host device of claim 21 wherein the execution logic is further configured to receive an input signal originating from the accessory via one of the plurality of host communication interfaces and to determine an action to take in response to the received input signal, wherein the determination is based in part on the input signal and in part on a determination as to which one of the accessory communication interfaces identified in the identification information sent the input signal.
